(19) United States
(12) Patent Application Publication
(10) Pub. No.: US 2021/0319385 A1
(43) Pub. Date: Oct. 14, 2021

(54) DYNAMIC USER ASSESSMENT OPTIMIZED BASED ON TIME AVAILABLE FOR ASSESSING

(71) Applicant: Synchrony Bank, Stamford, CT (US)

(72) Inventors: David Chau, Stamford, CT (US); Syed Kamran, Stamford, CT (US); Xuhui Li, Stamford, CT (US); Stephen Butler, Stamford, CT (US); Venkataramakrishna Narukulla, Stamford, CT (US); Richard Carrasco, Stamford, CT (US); Eswar Mamidi, Stamford, CT (US); Deepthi Potluri, Stamford, CT (US); Courtney Pitts, Stamford, CT (US); Nitin Kumar Vinod, Stamford, CT (US); Paul Aughey, Stamford, CT (US); Taylor Austin, Stamford, CT (US)

(73) Assignee: Synchrony Bank, Stamford, CT (US)

(21) Appl. No.: 17/230,656

(22) Filed: Apr. 14, 2021

Related U.S. Application Data
(60) Provisional application No. 63/009,545, filed on Apr. 14, 2020.

(51) Int. Cl. G06Q 10/06; G06Q 40/02

(52) U.S. Cl. CPC G06Q 10/06393; G06Q 40/025

(57) ABSTRACT

In response to receipt of a request for an assessment of a user at a system and from a client terminal, the system identifies a duration of time available for responding to the request and starts a timer. The system transmits requests for information about the user to data sources. The system can and receive some responsive datasets back from the data sources, and can determine which responsive datasets are optimal to wait for and which are not based on how closely the timer is approaching the duration of time available for responding to the request. The system generates the assessment of the user based on the datasets that the system received before the timer reached a threshold time that is based on the duration of time available for responding to the request, and sends the assessment of the user to the client terminal.

### CROSS-REFERENCE TO RELATED APPLICATIONS

The present invention claims the priority benefit of U.S. provisional patent application No. 63/009,545 filed Apr. 14, 2020 and titled “Dynamic Timed User Assessment Based on Multiple Data Sources,” the disclosure of which is incorporated by reference herein.

### BACKGROUND

### Field of the Invention

The present invention generally pertains to generating assessments of users dynamically based on time constraints. More specifically, the present invention pertains to generating an assessment of a user dynamically based on a duration of time available for responding to a request for the assessment of the user and based on optimal actions determined with respect to data sources.

### Description of the Related Art

Payment cards, such as credit cards and debit cards, are often used by customers during transactions with merchants. Merchants can read payment information from payment cards using payment card reader devices. Payment card reader devices include magnetic stripe reader devices that read payment card information from a magnetic stripe of a payment card that is swiped through a slot, Europay-Mastercard-Visa (EMV) chip reader devices that read payment card information from an EMV chip of a payment card that is inserted into a slot, or near field communication (NFC) reader devices that read payment card information wirelessly from an NFC-enabled payment card. Payment card reader devices read the payment card from a payment card, then send that payment card information to a server associated with a financial entity, such as a bank or credit card institution, in order to process the transaction by transferring funds from a customer account to a merchant account.

Credit cards or lines of credit can be provided to users by entities such as financial institutions, credit institutions, or merchants. Traditionally, these entities undergo thorough but lengthy analysis of a user before providing the user with a credit card or line of credit, which can be slow and inefficient, for example waiting long periods of time for data that might not end up being particularly important for the assessment. Alternately, these entities could undergo a shortened analysis of a user, which can lack thoroughness and miss important information even in situations when some of that information could be quickly obtained, and therefore can be risky.

Some merchants have membership or loyalty programs that customers can register for, either through payment or for free. A customer registered with a membership or loyalty program with a particular merchant can receive promotions from the merchant, for example after the customer spends a certain amount. Some payment cards may be branded according to a particular merchant. Merchants with such branded payment cards may likewise grant promotions to customers. Some merchants even allow customers to sign up for a branded payment card within their stores. However, merchants are generally not able to perform thorough assessments of the customers.

### SUMMARY

Systems and methods for dynamic timed decisioning are described. A request for an assessment of a user may be received at a dynamic timed decisioning system and from a client terminal. The dynamic timed decisioning system can identify a duration of time available for responding to the request, and can start a timer. The dynamic timed decisioning system transmits requests for information about the user to data sources. The dynamic timed decisioning system can receive some responsive datasets back from the data sources. The dynamic timed decisioning system can determine which responsive datasets are optimal to request and/or wait for, and which are not, for instance based on how closely the timer approaches to the duration of time available for responding to the request. The dynamic timed decisioning system generates the assessment of the user based on the datasets that the dynamic timed decisioning system received before the timer reached a threshold time that is based on the duration of time available for responding to the request, and sends the assessment of the user to the client terminal. Because the assessment is based on however much data the dynamic timed decisioning system was able to optimally obtain based on the duration of time available for responding to the request, the assessment can be thorough and secure while still remaining efficient and fast.

In one example, a method of dynamic timed decisioning is provided. The method includes: receiving, from a client terminal, a request for an assessment of a user; determining a duration of time available for responding to the request; starting a timer in response to receiving the request; transmitting a plurality of requests for information about the user to one or more data sources, the plurality of requests for information including at least a first request and a second request; receiving a first responsive dataset from the one or more data sources in response to transmission of the first request; determining, based on time still remaining on the timer following receipt of the first responsive dataset and on the duration of time available for responding to the request, that an optimal action for generating the assessment includes waiting for receipt of a second responsive dataset in response to transmission of the second request; receiving the second responsive dataset from the one or more data sources in response to transmission of the second request; determining, following receipt of the second responsive dataset, that the timer has counted at least a threshold duration of time, wherein the threshold duration of time is based on the time available for responding to the request; generating the assessment of the user based on the first responsive dataset and the second responsive dataset based on the timer having counted at least the threshold duration of time; and transmitting the assessment of the user to the client terminal based on timer having counted at least the threshold duration of time.

In another example, a system for dynamic timed decisioning is provided. The system includes communication transceiver, a memory storing instructions, and a processor that executes the instructions. Execution of the instructions by the processor causes the processor to: receive, from a client terminal at the communication transceiver, a request for an assessment of a user; determine a duration of time available for responding to the request; start a timer in response to receiving the request; transmit a plurality of requests for information about the user to one or more data sources using the communication transceiver, the plurality of requests for information including at least a first request and a second request; receive a first responsive dataset from the one or more data sources at the communication transceiver in response to transmission of the first request; determine, based on time still remaining on the timer following receipt of the first responsive dataset and on the duration of time available for responding to the request, that an optimal action for generating the assessment includes waiting for receipt of a second responsive dataset in response to transmission of the second request; receive the second responsive dataset from the one or more data sources at the communication transceiver in response to transmission of the second request; determine, following receipt of the second responsive dataset, that the timer has counted at least a threshold duration of time, wherein the threshold duration of time is based on the time available for responding to the request; generate the assessment of the user based on the first responsive dataset and the second responsive dataset based on the timer having counted at least the threshold duration of time; and transmit the assessment of the user to the client terminal using the communication transceiver based on timer having counted at least the threshold duration of time.

In another example, a non-transitory computer readable storage medium having embodied thereon a program is provided. The program is executable by a processor to perform a method of dynamic timed decisioning. The method includes: receiving, from a client terminal, a request for an assessment of a user; determining a duration of time available for responding to the request; starting a timer in response to receiving the request; transmitting a plurality of requests for information about the user to one or more data sources, the plurality of requests for information including at least a first request and a second request; receiving a first responsive dataset from the one or more data sources in response to transmission of the first request; determining, based on time still remaining on the timer following receipt of the first responsive dataset and on the duration of time available for responding to the request, that an optimal action for generating the assessment includes waiting for receipt of a second responsive dataset in response to transmission of the second request; receiving the second responsive dataset from the one or more data sources in response to transmission of the second request; determining, following receipt of the second responsive dataset, that the timer has counted at least a threshold duration of time, wherein the threshold duration of time is based on the time available for responding to the request; generating the assessment of the user based on the first responsive dataset and the second responsive dataset based on the timer having counted at least the threshold duration of time; and transmitting the assessment of the user to the client terminal based on timer having counted at least the threshold duration of time.

In another example, a system for dynamic timed decisioning is provided. The system includes: means for receiving, from a client terminal, a request for an assessment of a user; determining a duration of time available for responding to the request; means for starting a timer in response to receiving the request; means for transmitting a plurality of requests for information about the user to one or more data sources, the plurality of requests for information including at least a first request and a second request; means for receiving a first responsive dataset from the one or more data sources in response to transmission of the first request; means for determining, based on time still remaining on the timer following receipt of the first responsive dataset and on the duration of time available for responding to the request, that an optimal action for generating the assessment includes waiting for receipt of a second responsive dataset in response to transmission of the second request; means for receiving the second responsive dataset from the one or more data sources in response to transmission of the second request; means for determining, following receipt of the second responsive dataset, that the timer has counted at least a threshold duration of time, wherein the threshold duration of time is based on the time available for responding to the request; means for generating the assessment of the user based on the first responsive dataset and the second responsive dataset based on the timer having counted at least the threshold duration of time; and means for transmitting the assessment of the user to the client terminal based on timer having counted at least the threshold duration of time.

In some aspects, transmitting the plurality of requests includes transmitting the first request in parallel with transmitting the second request. In some aspects, transmitting the plurality of requests includes transmitting the first request before transmitting the second request. In some aspects, the optimal action includes transmitting the second request. In some aspects, transmitting the plurality of requests includes transmitting the first request after transmitting the second request.

In some aspects, receipt of the first responsive dataset occurs at a first time, and receipt of the second responsive dataset occurs at a second time after the first time.

In some aspects, generating the assessment includes generating a grade corresponding to a level of risk associated with the user, wherein the grade is within a range of possible grades. In some aspects, the grade corresponding to the level of risk associated with the user corresponds to a creditworthiness of the user. In some aspects, the assessment includes the grade.

In some aspects, the methods, apparatuses, and computer-readable medium described above further comprise: determining that the grade exceeds a predetermined grade threshold, wherein the assessment includes a recommendation to approve the user for at least one of a new credit account or a credit limit increase based on determining that the grade exceeds the predetermined grade threshold. In some aspects, the methods, apparatuses, and computer-readable medium described above further comprise: determining that the grade is less than a predetermined grade threshold, wherein the assessment includes a recommendation to decline the user for at least one of a new credit account or a credit limit increase based on determining that the grade is less than the predetermined grade threshold.

In some aspects, the methods, apparatuses, and computer-readable medium described above further comprise: receiving a third responsive dataset from the one or more data sources in response to transmission of a third request and after the timer has counted at least the threshold duration of time, wherein the plurality of requests for information include the third request, wherein the assessment is generated without use of the third responsive dataset in response to receipt of the third responsive dataset after the timer has counted at least the threshold duration of time. In some aspects, the methods, apparatuses, and computer-readable medium described above further comprise: receiving a third responsive dataset from the one or more data sources in response to transmission of a third request and before the timer has counted at least the threshold duration of time, wherein the plurality of requests for information include the third request, wherein the assessment is generated based also on the third responsive dataset in response to receipt of the third responsive dataset before the timer has counted at least the threshold duration of time.

In some aspects, the threshold duration of time is the duration of time available for responding to the request minus a predetermined assessment duration of time. In some aspects, the threshold duration of time is a predetermined percentage of the duration of time available for responding to the request.

In some aspects, a plurality of responsive datasets are received from the one or more data sources in response to transmission of the plurality of requests, wherein the plurality of responsive datasets includes the first responsive dataset and the second responsive dataset, wherein the plurality of responsive datasets includes a Fair Isaac Corporation (FICO)® score, wherein the assessment is generated based on the FICO® score.

In some aspects, a plurality of responsive datasets are received from the one or more data sources in response to transmission of the plurality of requests, wherein the plurality of responsive datasets includes the first responsive dataset and the second responsive dataset, wherein the plurality of responsive datasets includes information indicating a change in a property of the user, wherein generating the assessment of the user is based on the change in the property of the user, wherein the property of the user corresponds to one of a marriage status of the user, an employment status of the user, a dependent status of the user, an address of the user, and a name of the user.

In some aspects, a plurality of responsive datasets are received from the one or more data sources in response to transmission of the plurality of requests, wherein the plurality of responsive datasets includes the first responsive dataset and the second responsive dataset, wherein the plurality of responsive datasets includes information indicating a plurality of changes in a parameter associated with the user over an assessed period of time, wherein the assessment is generated based on the plurality of changes in the parameter associated with the user over the assessed period of time. In some aspects, the methods, apparatuses, and computer-readable medium described above further comprise: determining a trajectory of values for the parameter over the assessed period of time based on the plurality of changes in the parameter over the assessed period of time, wherein the assessment is generated based on the trajectory of values for the parameter over the assessed period of time. In some aspects, the methods, apparatuses, and computer-readable medium described above further comprise: determining a sum of the plurality of changes in the parameter associated with the user over the assessed period of time, wherein the assessment is generated based on a comparison between the sum and a threshold value.

In some aspects, the apparatus includes a mobile device, a mobile telephone, a smart phone, a mobile handset, a wireless communication device, a personal computer, a laptop computer, a server computer, or another computing device.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a block diagram illustrating a system architecture for a user assessment and decisioning system.

FIG. 2 is a block diagram illustrating operations and components of a user assessment and decisioning system for dynamic timed decisioning.

FIG. 3 is a flow diagram illustrating operations for dynamic timed decisioning.

FIG. 4 is a block diagram illustrating a system architecture of a data lake system for analysis of time-based event data.

FIG. 5 is a block diagram illustrating operations and components of a user assessment and decisioning system with self-healing micro-services.

FIG. 6 is a block diagram illustrating a system architecture of a data lake system for self-healing micro-services.

FIG. 7 is a flow diagram illustrating operations for dynamic timed decisioning.

FIG. 8 is a block diagram illustrating a system architecture of a user assessment and decisioning system with an analysis engine, a choreography engine, and a strategy engine.

FIG. 9 is a block diagram illustrating a system architecture of a user assessment and decisioning system with a communication system, an analysis system, and a strategy system.

FIG. 10 is a block diagram of an exemplary computing device that may be used to implement some aspects of the technology.

### DETAILED DESCRIPTION

Credit cards or lines of credit can be provided to users by entities such as financial institutions, credit institutions, or merchants. It can be helpful for such entities to generate an assessment of the user to use in assessing whether to allow or decline a request for a transaction, such as a new credit card, a new line of credit, and adjustment to a credit limit, or the line. Thorough but lengthy analyses of a user can be too slow and inefficient in some cases, and can sometimes hang up indefinitely due to issues with an unreliable data source that might not even be providing particularly important data. Shortened analyses of the user, can lack thoroughness and miss important information, even in situations when some of that information could be quickly obtained, and therefore can be risky. Furthermore, in some cases, a thorough analysis of a user can be quick, while in other cases a thorough analysis of the user may be slow and lengthy. As such, a static user assessment system can be slower than necessary in some cases, and not thorough enough in some cases.

Techniques and technologies for dynamic timed decisioning are described herein. A request for an assessment of a user may be received at a dynamic timed decisioning system and from a client terminal. The dynamic timed decisioning system can identify a duration of time available for responding to the request, and can start a timer. The dynamic timed decisioning system transmits requests for information about the user to data sources. The dynamic timed decisioning system can receive some responsive datasets back from the data sources. The dynamic timed decisioning system can determine which responsive datasets are optimal to request and/or wait for, and which are not, for instance based on how closely the timer approaches to the duration of time available for responding to the request. The dynamic timed decisioning system generates the assessment of the user based on the datasets that the dynamic timed decisioning system received before the timer reached a threshold time that is based on the duration of time available for responding to the request, and sends the assessment of the user to the client terminal. Because the assessment is based on however much data the dynamic timed decisioning system was able to optimally obtain based on the duration of time available for responding to the request, the assessment can be thorough and secure while still remaining efficient and fast.

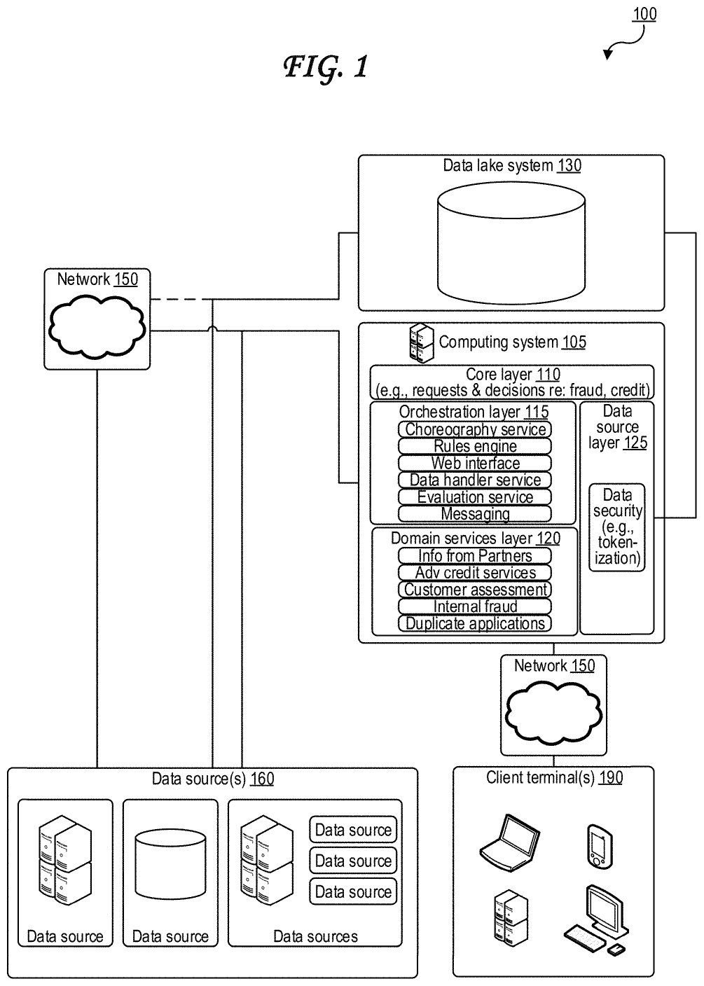

FIG. 1 is a block diagram illustrates a system architecture 100 for a user assessment and decisioning system. In particular, the architecture 100 of FIG. 1 includes a computing system 105 coupled to a data lake system 130. The computing system 105 and the data lake system 130 are coupled to one or more data source(s) 160, either directly, through a network connection over a network 150 (e.g., a public network 150 such as the Internet and/or a private network 150 such as a LAN and/or WLAN), or some combination thereof. The computing system 105 is coupled to one or more client terminals 190 over a network connection over a network 150 (e.g., a public network 150 such as the Internet and/or a private network 150 such as a LAN and/or WLAN). In some cases, the computing system 105 may be referred to as the remote computing system, the network computing system, the server system, the unit of compute, the unit of computing, or some combination thereof.

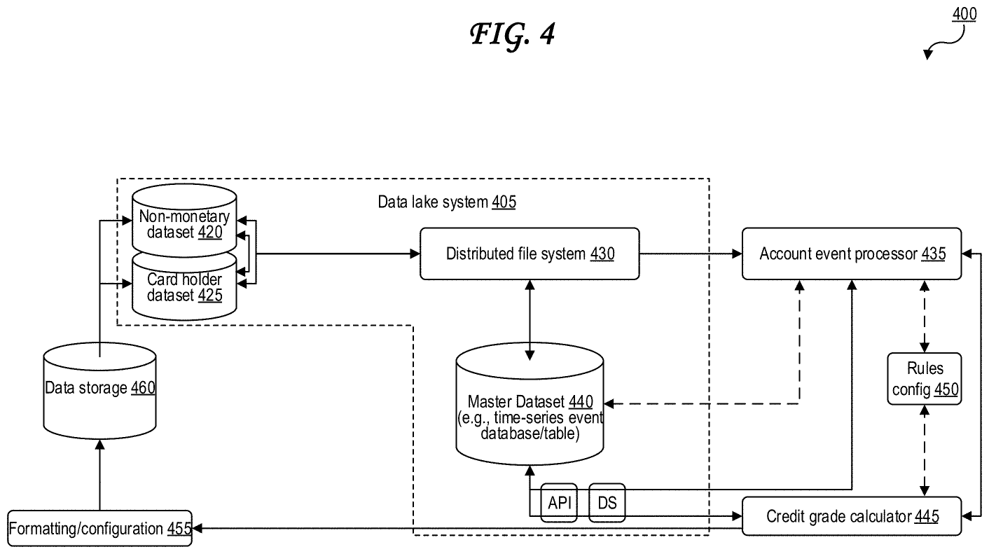

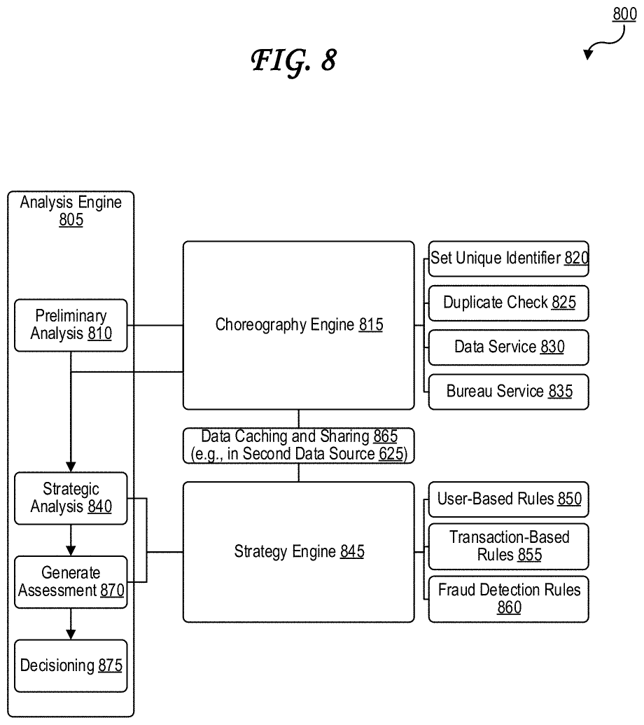

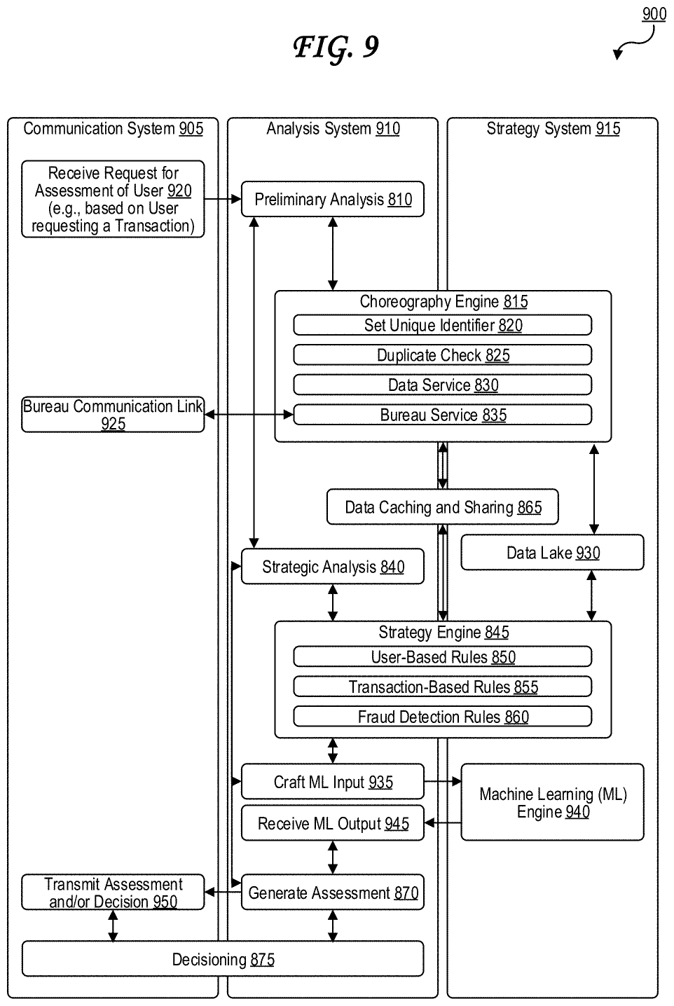

The computing system 105 includes various systems running various system layers, including a core layer 110, an orchestration layer 115, a domain services layer 120, and a data source layer 125. The core layer 110 may receive (e.g., from client terminals 190) requests for assessments and decisions about a user, the assessments and decisions generally relating to fraud, creditworthiness, financial well-being, other types of assessments, or some combination thereof. The orchestration layer 115 includes tools enabling the core layer 110 to generate the assessments and decisions, including a choreography service that queues and schedules requests and assessment generation, a rules engine that provides rules for making assessments and decisions, a web interface for the client terminal(s) 190, a data handler that handles receipt of data from the data lake system 130 and transmission of data to the data lake system 130, an evaluation service that generates assessments based on the data from the data lake system 130 and the rules from the rules engine, and a messaging service that allows the various layers and services of the computing system 105 to interact with one another and with the data lake system 130. The domain services layer 120 provide services for the client terminal(s) 190 using the orchestration layer 115 and data source layer 125, such as sharing of information from partner organizations, advanced credit services, customer assessments, internal fraud assessments, and duplicate applications. The data source layer 125 interacts with and handles receipt of data from the data lake system 130 and transmission of data to the data lake system 130, and may include data security precautions such as a firewall and/or a data tokenization service. In some examples, the rules of the rules engine of FIG. 1 may include the rules of the rules engine 235, the rules of the rules configuration 450 of FIG. 4, the user-based rules 850 of FIGS. 8-9, the transaction-based rules 855 of FIGS. 8-9, the fraud detection rules 860 of FIGS. 8-9, or a combination thereof.

The data lake system 130 may include one or more databases, for example one or more time-series databases. The data lake system 130 may retrieve, organize, and store data. The data that is retrieved, organized and stored by the data lake system may include data from the various data sources 160, data (e.g., requests) received from client terminals 190), data (e.g., decisions and analyses and assessments) generated by the computing system 105, or some combination thereof. The data lake system architecture 400 of FIG. 4 is one example of a data lake system 130.

The data sources 160 may include various types of data sources. For example, a set of one or more computers included in the data sources 160 may itself be a data source. A hard drive or other computer-readable storage medium may be a data source, particularly when read by a computing device of the data sources 160. A set of one or more computing devices included in the data sources 160 may include multiple disparate data sources, for example one data source with transaction history, one data source with address changes, one data source with name changes, and so forth. The computing system 105 and data lake system 130 may retrieve data from any combination of the various data sources, and various types of data sources, of the data sources 160.

The client terminals 190, which may be referred to as client devices 190, may include various computing devices used by clients. The client devices 190 may transmit requests to the computing system 105 over the network 150, and may receive responses back from the computing system 105 over the network 150. The requests may be requests for assessments of one or more users, and the responses may be the assessments of the one or more users as generated by the computing system 105. In some cases, client terminals 190 may be POS devices at merchant locations, where the merchant is trying to determine whether to allow a customer to enroll in a credit card and/or credit account associated with the merchant, and is relying on receiving an assessment of the customer to make this determination.

As discussed further herein, these assessments may be generated by the computing system 105 based on a variety of types of information about the user retrieved by the computing system 105 from the data lake system 130 and/or data sources 160. The assessments may include credit grades or scores corresponding to a creditworthiness of the user. The assessments may be decisions, which may be made based on whether or not the credit grades or scores exceed or fall below a predetermined credit grade or score threshold. The decisions may include decisions as to whether or not to grant the user a new credit account (e.g., a new credit card associated with an account), a credit limit increase (e.g., on an existing account), or some combination thereof.

The computing system 105, data lake system 130, client terminals 190, and data sources 160 all may include one or more computing system 1000 and/or may include at least a subset of the components of a computing system 1000.

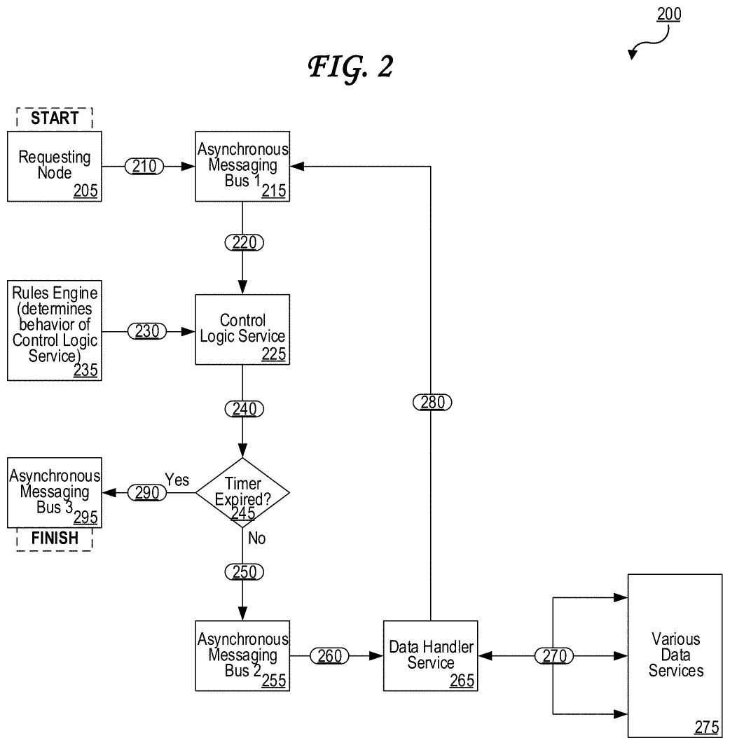

FIG. 2 is a block diagram 200 illustrating operations and components of a user assessment and decisioning system for dynamic timed decisioning. The block diagram 200 of FIG. 2 illustrates dynamic timed decisioning operations. The operations may, in some cases, start at block 205, as indicated by the dashed “start” block. The operations may, in some cases, end at block 295, as indicated by the dashed “end” block.

Block 205 represents a requesting node, which may be a client terminal 190. The requesting node block 205 transmits a message 210 to the asynchronous messaging bus 1 block 215. In some cases, the message 210 may use a specific schema, which may for instance include formatting, syntax, and data types. For instance, the schema may be denoted in Extensible Markup Language (XML) or another type of markup language. The schema may indicate that certain variables corresponding to timers, data, rules, and so forth should hold certain data types, such as integers, strings, characters, floating point numbers, fixed point numbers, big integers, Boolean values, enumerated values, or other data types.

The asynchronous messaging bus 1 block 215 is part of the computing system 105. The message may include a request for an assessment of a user, such as a request for a credit decision. The asynchronous messaging bus 1 block 215 transmits the request on to the control logic service 225 within the message 220. The message 220 may preserve the schema of the message 210, for instance by preserving the formatting/syntax and/or by preserving the data types of the different variables. The control logic service 225 is an example of the evaluation service of the orchestration layer 115 of the computing system 105 of FIG. 1. The control logic service 225 may also receive rules 230 from the rules engine 235, which may also be part of the orchestration layer 115 of the computing system 105 of FIG. 1. In some examples, the rules of the rules engine 235 may include the rules of the rules engine of FIG. 1, the rules of the rules configuration 450 of FIG. 4, the user-based rules 850 of FIGS. 8-9, the transaction-based rules 855 of FIGS. 8-9, the fraud detection rules 860 of FIGS. 8-9, or a combination thereof.

The control logic service 225 performs a process 240 that begins a timer and begins the process of generating an assessment of the user to respond to the request from the message 210. At a decision point 245, the control logic service 225 determines if the time has expired. If the timer has not expired at the decision point 245, the control logic service 225 may update the message 220 in some cases, for example to generate and add to the message 220 a preliminary assessment of the user while preserving the schema of the message 210. The control logic service 225 sends the updated message on to the asynchronous messaging bus 2 255 as the message 250. The message 250 is sent on from the asynchronous messaging bus 2 255 to the data handler service 265 as the message 260. The data handler service 265 may also be part of the orchestration layer 115 of the computing system 105 of FIG. 1.

The data handler service 265 communicates with various data services 275 over one or more communications 270. The one or more communications 270 include requests for information about the user transmitted by the data handler service 265 to the various data services 275. The various data services 275 may include the data sources 160 of FIG. 1. The one or more communications 270 include datasets of information about the user transmitted by the various data services 275 back to the data handler service 265. The data handler service 265 retrieves one or more of the datasets from the various data sources 275 and updates the message 260 into the message 280, which includes information from the one or more retrieved datasets, and which the data handler service 265 sends to the asynchronous messaging bus 1 215. The message 280 may preserve the schema of the message 210. In some cases, preserving the schema of the message 210 may include reformatting or converting newly received data from the data sources 275 from one or more schema(s) used by the data sources 275 to fit into the existing schema of the message 210. For example, data received from the data sources 275 may be parsed and a particular element of data may be extracted, and that element of data may then be inserted into a field in the message 280 using the existing schema of the message 210. The data handler service 265 need not wait until it receives all of the datasets from the various data services 275 that are responsive to the requests that the data handler service 265 sent to the various data services 275.

Once the asynchronous messaging bus 1 215 receives the message 280 from the data handler service 265, the asynchronous messaging bus 1 215 sends the message 280 back to the control logic service as the message 220. The control logic service 225 considers the new information from the data handler service 265 and updates the message with an assessment of the user that it generates based on the new information from the data handler service 265 and based on the rules 230 from the rules engine 235. The data handler service 265 again determines at decision point 245 whether the timer has expired. If the timer has not expired at the decision point 245, the process with blocks 255, 265, 275, 215, 225, and messages 250, 260, 270, 280, 220, and 240 repeats for another cycle, with the data handler service 265 potentially receiving additional datasets from the various data sources 275 that are responsive to the requests that the data handler service 265 sent to the various data services 275, and the control logic service 225 may update its assessment based on the additional information from the data handler service 265.

If the timer has expired at the decision point 245, the message that is continually updated and that now includes the assessment generated by the control logic service 225 is transmitted to the asynchronous messaging bus 3 295 as message 290. The asynchronous messaging bus 3 295 sends the message 290 back to the requesting node 205, or to another service (not pictured) within the computing system 105 that sends the message 290 on to the requesting node 205. Thus, the requesting node 205 receives the assessment of the user generated by the control logic service 225.

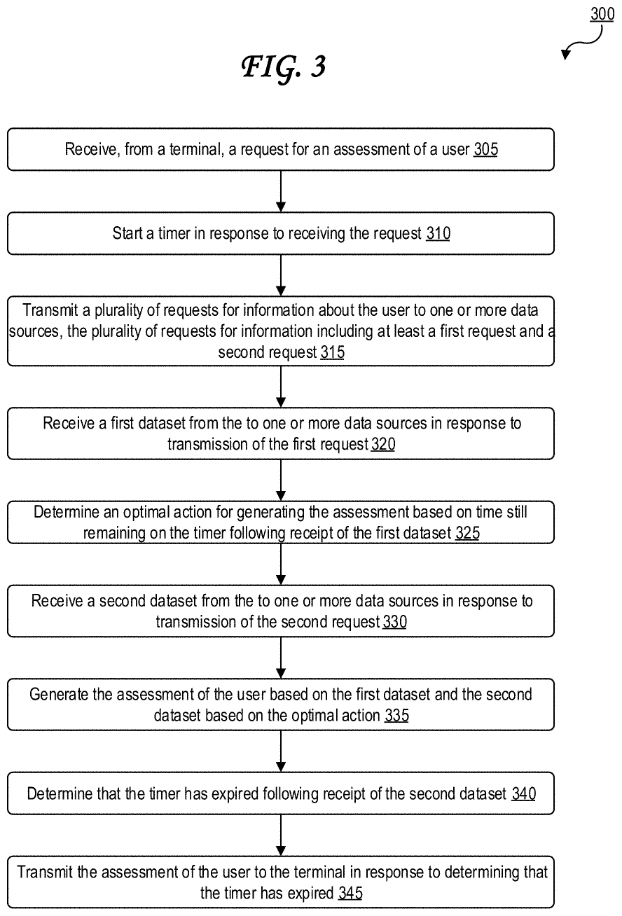

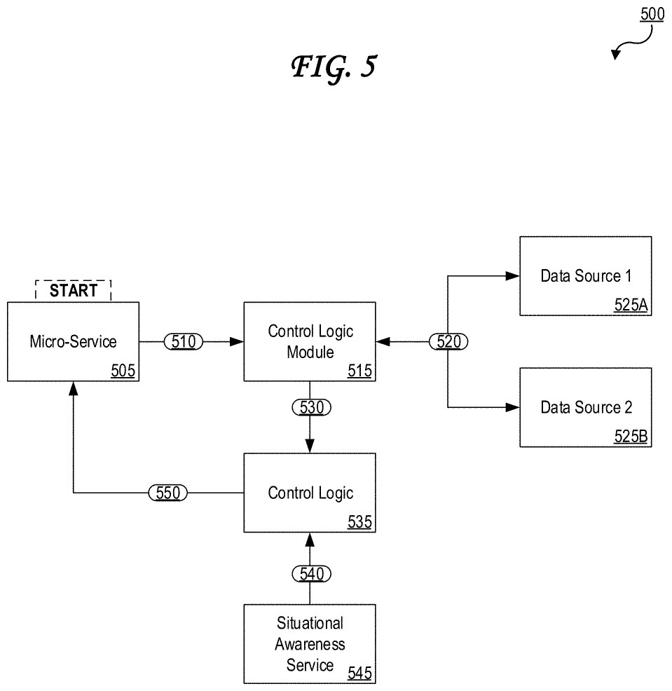

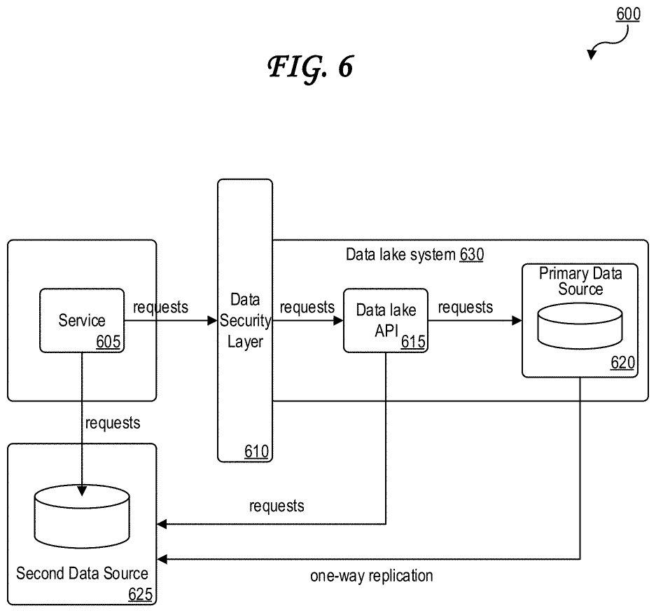

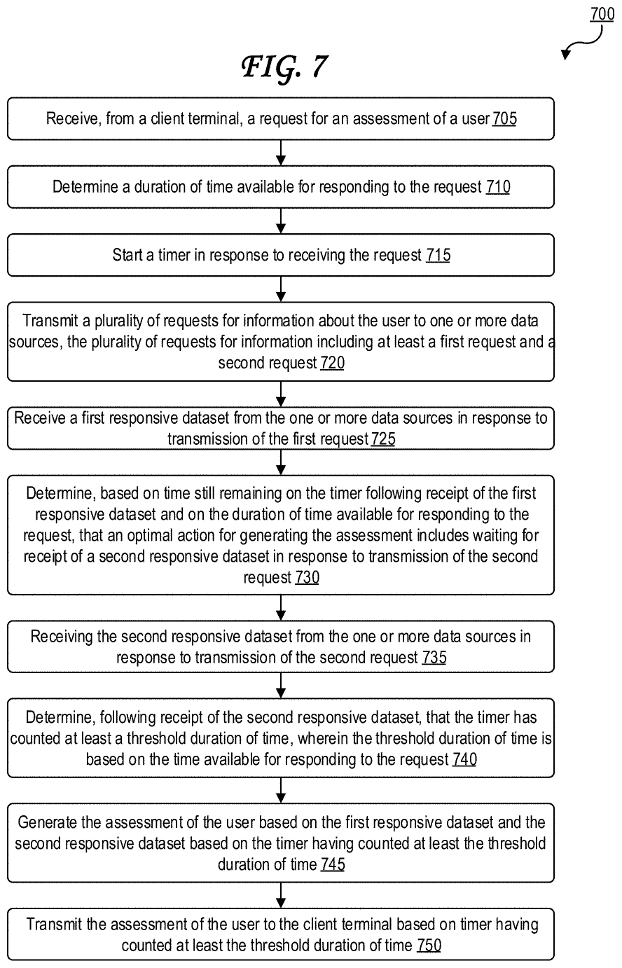

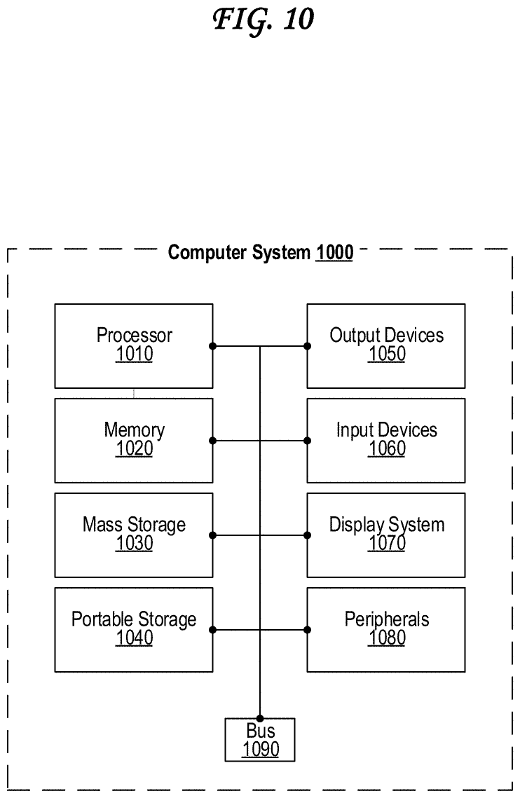

FIG. 3 is a flow diagram illustrating operations 300 for dynamic timed decisioning. The operations 300 of FIG. 3 are performed by a dynamic timed decisioning system. The dynamic timed decisioning system may be, and/or may include, the computing system 105 of FIG. 1, the data lake system 130 of FIG. 1, the user assessment and decisioning system of FIG. 2, the data lake system of FIG. 4, the user assessment and decisioning system of FIG. 5, the data latke system of FIG. 6, the dynamic timed decisioning system of FIG. 7, the user assessment and decisioning system 800 of FIG. 8, the user assessment and decisioning system 900 of FIG. 9, the computing device 1000 of FIG. 10, or a combination thereof.

At operation 305, the dynamic timed decisioning system receives from a terminal (e.g., a client terminal 190), a request for an assessment of a user. The terminal can include, for example, the client terminal 190 of FIG. 1, the requesting node 205 of FIG. 2, the client terminal of operations 705 and 750, a user device associated with the user, a merchant device associated with a merchant, a financial institution device associated with a financial institution, a credit institution device associated with a credit institution, or a combination thereof. The request for the assessment of the user may be received based on the user requesting a transaction, such as one or more purchases by the user from the entity, rentals by the user from the entity, applications for credit (e.g., for a new line of credit, a new loan, a new credit card) by the user from the entity, changes to credit (e.g., requesting a credit limit increase or other adjustment to a line of credit) by the user from the entity, or a combination thereof. Operations 705 and/or 920 may be examples of operation 305, and vice versa.

At operation 310, the dynamic timed decisioning system starts a timer in response to receiving the request. The timer may be the timer of FIG. 2 and/or the timer of FIG. 7. The timer may start from the time of receipt of the request for the assessment of the user. The timer may start from the time of transmission of the request for the assessment of the user. The timer may start a time at which one of the operations 305-335 occurs, begins, or completes.

At operation 315, the dynamic timed decisioning system transmits a plurality of requests for information about the user to one or more data sources. The plurality of requests for information include at least a first request and a second request. In some cases, the requests may be referred to as queries, and transmitting the requests may be referred to as querying a data source. The one or more communications 270 to the various data services 275 of FIG. 2 may be examples of the plurality of requests for information about the user transmitted to the one or more data sources of operation 720. The one or more communications 520 sent to the data source 1 525A and/or the data source 2 525B of FIG. 2 may be examples of the plurality of requests for information about the user transmitted to the one or more data sources of operation 720. The one or more requests sent from the service 605 of FIG. 6 may be examples of the plurality of requests for information about the user transmitted to the one or more data sources of operation 720. Examples of the one or more data sources may include the various data services 275, the data lake system 405, the master dataset 440, the credit grade calculator 445, the data storage 460, the non-monetary dataset 420, the card holder dataset 425, the distributed file system 430, the data source 1 525A, the data source 2 525B, the primary data source 620, the second data source 625, the data lake system 630, the data lake 930, or a combination thereof. Operation 720 may be an example of operation 315, or vice versa.

At operation 320, the dynamic timed decisioning system receives a first dataset from the to one or more data sources in response to transmission of the first request. The one or more communications 270 from the various data services 275 of FIG. 2 may be examples of responsive datasets such as the first dataset. The one or more communications 520 received from the data source 1 525A and/or the data source 2 525B of FIG. 5 may be examples of the first dataset from the one or more data sources. The first responsive dataset of operation 725 may be an example of the first dataset of operation 320, or vice versa. Operation 725 may be an example of operation 320, or vice versa.

At operation 325, the dynamic timed decisioning system determines an optimal action for generating the assessment based on time still remaining on the timer following receipt of the first dataset. The timer may count up or down, and may count as “expired” when the timer has counted a threshold duration of time that is based on a duration of time available for responding to the request of operation 305. Operation 245 may be an example of operation 325, or vice versa. Operation 730 may be an example of operation 325, or vice versa.

At operation 330, the dynamic timed decisioning system receives a second dataset from the to one or more data sources in response to transmission of the second request. The one or more communications 270 from the various data services 275 of FIG. 2 may be examples of responsive datasets such as the second dataset. The one or more communications 520 received from the data source 1 525A and/or the data source 2 525B of FIG. 5 may be examples of the second dataset from the one or more data sources. The second responsive dataset of operation 735 may be an example of the second dataset of operation 330, or vice versa. Operation 735 may be an example of operation 330, or vice versa.

At operation 335, the dynamic timed decisioning system generates the assessment of the user based on the first dataset and the second dataset based on the optimal action. The credit grade generated by the credit grade calculator 445 may be an example of the assessment of operation 335. The assessment generated at the generate assessment operation 870 of FIGS. 8 and/or 9 may be examples of the assessment of operation 335. The decision generated at the decisioning operation 875 of FIGS. 8 and/or 9 be examples of the assessment of operation 745. Operation 745 may be an example of operation 335, or vice versa.

At operation 340, the dynamic timed decisioning system determines that the timer has expired following receipt of the second dataset, and in some cases following generation of the assessment of the user. The timer may count up or down, and may count as “expired” when the timer has counted a threshold duration of time that is based on a duration of time available for responding to the request. Operation 245 may be an example of operation 340, or vice versa. Operation 740 may be an example of operation 340, or vice versa.

At operation 345, the dynamic timed decisioning system, transmits the assessment of the user to the terminal 345 in response to determining that the timer has expired. The transmission of the assessment and/or decision operation 950 of FIG. 9 may be an example of the transmission of the assessment of the user to the client terminal of operation 345. Operation 750 may be an example of operation 345, or vice versa.

Regarding operation 325, the optimal action may, in some cases, be determined based on how much time remains on the timer, on pre-determined priorities (e.g., levels of importance or weight values in determining in the assessment) associated with certain data sources and types of data from those data sources, on whether a query has been sent to the data source already, on when the query was sent to the data source, on estimates of how much time it will take to receive the types of data in question from those data sources, on estimates of how much time it will take to process the types of data in question from those data sources upon receipt, whether data can be used alone in generating the assessment or requires additional data from another source to be used in generating the assessment, or some combination thereof. For example, if five data sources are queried and the first and third are highest priority, but the third will take too long (more than remains on the timer) to receive data from and/or to process the data into a form that is useful for generating, and the fourth and fifth are only useful if they are both received and processed within the time remaining on the timer, then the optimal action may be to use data from the first and second data sources.

In some cases, the pre-determined priorities may be updated by the dynamic timed decisioning system as the dynamic timed decisioning system receives more data and generates more assessments, for instance based on how accurate those assessments turn out to be. If feedback is received indicating that an assessment was inaccurate, then the priorities of data used in that assessment may be dropped by a predetermined amount. If feedback is received indicating that an assessment was accurate, then the priorities of data used in that assessment may be increased by a predetermined amount, or kept the same. The dynamic timed decisioning system may use a trained machine learning (ML) algorithm, such as a trained neural network (NN), to update the priorities based on feedback. Priorities may be associated with data sources, with data types, or some combination thereof. Similarly, estimates for how much time it will take to receive and/or process a particular type of data from a particular data source may be updated based on how much time it actually takes to receive and/or process that particular type of data from that particular data source during previous executions of the operations 300. The dynamic timed decisioning system may use a machine learning algorithm, such as a neural network, to update the time estimates based on measured times used as training data.

Regarding operation 335, in some cases the assessment is generated within the time allotted by the timer (e.g., before the time expires), while in other cases, the assessment is generated after the timer expires. If the dynamic timed decisioning system's rules require the assessment to be generated within the time allotted by the timer (e.g., before the time expires), then the optimal action may include generation of the assessment. Operation 335, and must take into account any processing time required to generate the assessment At operation 335. If the assessment is generated before the timer expires, then the determination that the timer has expired. Operation 340 may occur following generation of the assessment in addition to following receipt of the second dataset.

In some cases, the requests that are transmitted from the dynamic timed decisioning system to the data sources. Operation 315 may include amounts of time within which the dynamic timed decisioning system requests a response from the data source. This amount of time may be based on a remaining time on the timer. For instance, if the remaining time on the timer is 500 ms, the request may indicate that the data should be received within 500 ms, or even within a smaller amount of time, such as 400 ms or 300 ms, in order to reserve time for processing the received data to generate the assessment and/or for ultimately generating the assessment based on the data. In some cases, a request may be submitted to multiple data sources with the time amount, so that the multiple data sources can bid on which of them can provide the requested data within the requested time, most cheaply, fastest, or some combination thereof.

FIG. 4 is a system architecture block diagram for a data lake system for analysis of time-based event data.

The architecture 400 of FIG. 4 includes a data lake system 405. The data lake system 130 of FIG. 1 may include at least a subset of the data lake system 405, at least a subset of the architecture 400, or some combination thereof. The architecture 400 and/or the data lake system 405 may in some cases include elements of the computing system 105 of FIG. 1.

The data lake system 405 includes a non-monetary dataset 420, a card holder dataset 425, a distributed file system 430, and a master dataset 440. The non-monetary dataset 420 may include non-monetary information about various users, such as users' names, addresses, telephone numbers, marriage status, and the like. The card holder dataset 425 financial data associated with one or more users, for example transaction histories of the users, credit accounts associated with the users, credit limits of the users, Fair Isaac Corporation (FICO)® credit scores of the users, credit bureau ratings (CBR) of users, VantageScores® of users, Stripe® Radar® scores of users, and the like. The master dataset 440 may be, or may include, a time-series event database or table.

The data lake system 405 periodically polls the non-monetary dataset 420 and filters only data needed to populate the time-series event database/table of the master dataset 440, which is transferred to the distributed file system 430. The data lake system 405 analyzes the data from the non-monetary dataset 420 that is in the distributed file system 430 to determine particular card holder accounts to read from the card holder dataset 425. The data lake system 405 then retrieves financial data from the card holder dataset 425 related to those particular card holder accounts and/or additional card holder accounts as needed to populate the time-series event database/table of the master dataset 440, and stores that data at the distributed file system 430.

The distributed file system 430 uploads the data collected at the distributed file system 430 from the non-monetary dataset 420 and the card holder dataset 425 to the master dataset 440. In some cases, this is done using a bulk data loader. In some cases, only data which has changed relative to the most recent corresponding data in the master dataset 440 will be added/appended/written into the master dataset 440. For example, if a user's address is retrieved from the non-monetary dataset 420 but is the same as the most recently identified address for that user in the master dataset 440, then no new entry is added. On the other hand, if the user's address is retrieved from the non-monetary dataset 420 but is different compared to the most recently identified address for that user in the master dataset 440, then a new entry identifying the new address is appended to the master dataset 440. In some cases, entries are never deleted from the master dataset 440, so that old data, such as previous addresses of a user, can still be accessed. Entries may instead be timestamped or sorted from most recent to least recent (or vice versa) so that it is clear which entry is most recent (e.g., which address of the user is current).

Once the master dataset 440 has been updated, the master dataset 440, the distributed file system 430, another portion of the data lake system 405, or some combination thereof may identify which accounts underwent changes, and may notify the account even processor 435 of these changes. The account event processor 435 may be part of the computing system 105. The account event processor 435 may be notified of the changes to the accounts, in some cases, and may be notified via a message identifying an account number (or other identifier) of each account that underwent a change, an event time stamp associated with the change, and in some cases the event that occurred at that timestamp (e.g., change of address). In some cases, the account event processor 435 may request additional information from the master dataset 440, for instance by querying the master dataset 440 based on the account number and/or the event timestamp. In some cases, the account event processor 435 may request historical information about one or more events preceding the timestamp as well as information about the event associated with the timestamp. The response received by the account event processor 435 from the master dataset 440 may include information about the event associated with the timestamp and/or historical information about one or more events preceding the timestamp. The response received by the account event processor 435 from the master dataset 440 may include, for example, an account number, an event timestamp, a FICO® credit score (or new address or other change), a credit bureau ratings (CBR) (or no-hit indicator), a VantageScore®, a Stripe® Radar® score, a client number (e.g., of a client terminal 190 requesting an assessment of the user associated with this account), a system number, a principle number, an agent number, or some combination thereof.

The account event processor 435 may receive rules from a rules configuration 450. The account event processor 435 may then evaluate data for the account event and/or the historical data based on the set of rules from the rules configuration 450. If one or more rules apply, the account event processor 435 transfers the corresponding account data to the credit grade calculator 445. Rules may include, for example, certain thresholds or ranges for values, such as for a user's age, income, bank account balance, balance due, debt balance, repaid debt balance, FICO® credit score, credit bureau rating (CBR) (or no-hit indication), VantageScore®, Stripe® Radar® score, other types of scores/ratings/values discussed herein, or some combination thereof. For instance, a positive/good assessment may be generated for a user (e.g., a good credit grade may be generated and/or the user may be approved for a loan or other program) if the user's age is within an income-earning age range, the user's income exceeds an income threshold, the user's bank account balance exceeds a bank balance threshold, the user's balance due falls below a balance due threshold, the user's debt balance falls below a debt balance threshold, the user's repaid debt balance exceeds a repaid debt balance threshold, the user's FICO® credit score exceeds a FICO® credit score threshold, the user's credit bureau rating exists (does not return a no-hit indication) and is from a reputable credit bureau and exceeds a credit bureau rating threshold, the user's VantageScore® exceeds a VantageScore® threshold, the user's Stripe® Radar® score exceeds a Stripe® Radar® score threshold, or some combination thereof. Similarly, a poor/negative assessment may be generated for a user (e.g., a low credit grade may be generated and/or the user may be declined for a loan or other program and/or the user's account may be frozen) if the user's age falls outside of an income-earning age range, the user's income falls below an income threshold, the user's bank account balance falls below a bank balance threshold, the user's balance due exceeds a balance due threshold, the user's debt balance exceeds a debt balance threshold, the user's repaid debt balance falls below a repaid debt balance threshold, the user's FICO® credit score falls below a FICO® credit score threshold, the user's credit bureau rating exists (does not return a no-hit indication) and is from a reputable credit bureau and falls below a credit bureau rating threshold, the user's VantageScore® falls below a VantageScore® threshold, the user's Stripe® Radar® score falls below a Stripe® Radar® score threshold, or some combination thereof.

In some cases, rules make take into account historical data over a time period, such as gradual changes to a FICO® credit score over time that together add/sum up to a large change exceeding or falling below a threshold, or that have an average slope or trajectory over the period of time (e.g., when graphed) that exceeds or falls below a threshold. In some cases, rules may have exceptions, in which case a value exceeding or falling below a threshold may not have the effect it normally would have due to a certain characteristic of the user, an account, a country and/or local laws, or some combination thereof. In some cases, triggering of certain rules may result in output of reason codes associated with those rules. For instance, if a user's loan is declined primarily because their FICO® credit score falls below a threshold, the assessment may include a reason code, which may be a number of a string of characters, and that can correspond to “low FICO® credit score” if looked up in a look-up table. Some rules may check for errors in data, for example by checking if a value is within a valid range, and not considering the value within the final assessment of the user if the value is outside of the valid range (or in an invalid range). For example, if the user's age is zero, or is negative, then the error-checking rule can indicate that there is likely an error in the user's age data, and the age should not be considered in the assessment. The account data transferred from the account event processor 435 to the credit grade calculator 445 may include any of the data discussed above as having been received by the account event processor 435, such as the account number, a new credit score (or address or other change), and/or an event timestamp. In some examples, the rules of the rules configuration 450 of FIG. 4 may include the rules of the rules engine of FIG. 1, rules of the rules engine 235, the user-based rules 850 of FIGS. 8-9, the transaction-based rules 855 of FIGS. 8-9, the fraud detection rules 860 of FIGS. 8-9, or a combination thereof.

The credit grade calculator 445 receives the account information from the account event processor 435 and in some cases requests additional data from the master dataset 440. The request may include, for example account number and event timestamp. The additional data received at the credit grade calculator 445 from the master dataset 440 may include, for example, any information previously discussed as added to the master dataset 440 or as sent from the master dataset 440 to the account even processor 435, as well as an account number, a client number, a system number, a principle number, an agent number, a behavior score, an external status, a current balance, an existing credit, or some combination thereof. In some cases, the credit grade calculator 445 may interface with the master dataset 440 through a data reading application programming interface (API) and/or a data security (DS) service such as a firewall or data tokenization service.

The credit grade calculator 445 calculates a credit grade for the account, or updates/recalculates the credit grade for the account if a previous credit grade was already calculated and retrieved from the master dataset 440. The credit grade generated by the credit grade calculator 445 is distinct from a credit score such as the FICO® credit score or similar score in that it may take into account a variety of data sources, including FICO® credit score data, credit bureau rating (CBR) data (or no-hit indicator), VantageScore® data, Stripe® Radar® score data, transaction data, non-monetary data, or combinations thereof. In some cases, this credit grade may serve as the assessment of the user in operation 340 of FIG. 3.

The credit grade calculator 445 may transfer the updated/recalculated credit grade and/or additional information to the master dataset 440 directly in some cases, and the master dataset 440 may store the updated/recalculated credit grade and/or the additional information. The credit grade calculator 445 may alternately or additionally transfer the updated/recalculated credit grade and/or the additional information to a data storage system 460, in some cases after being modified through an aggregation/formatting/configuration service 455. In some cases, the updated/recalculated credit grade and/or the additional information may be transferred to the data storage system 460 using an Apache® Spark™ job and/or an Apache® Kafka® topic. The data lake system 405 may retrieve data from the data storage system 460 to populate the non-monetary dataset 420 and/or the card holder dataset 425, and the cycle may continue. In some cases, the additional information transferred along with the updated/recalculated credit grade by the credit grade calculator 445 may include an account number, some non-monetary information, various flags detailing status or properties of an account or user, nonce/filler data (e.g., a number of bytes), a terminal/device identifier, an operator code (e.g., AM).

FIG. 5 is a block diagram illustrating techniques and technologies for self-healing micro-services.

The block diagram 500 of FIG. 5 illustrates self-healing micro-service operations. The operations may, in some cases, start at block 505, as indicated by the dashed “start” block.

Block 205 represents a micro-service. As a time-sensitive micro-service may require data from a data source, the micro-service 505 sends a request 510 for data to the control logic module 515. The control logic module 515 may be an independent code component of the micro-service 505.

The control logic module 515 may request and receive data from one or more data sources via one or more communications 520. In particular, two data sources are illustrated—a data source 1 525A and a data source 2 525B. The one or more communications 520 include requests for data that the control logic module 515 sends to the data source 1 525A and the data source 2 525B in parallel. The one or more communications 520 may include data received by the control logic module 515 from the data source 1 525A and the data source 2 525B. The data from the data source 1 525A and the data source 2 525B may be received asynchronously by the control logic module 515 rather than simultaneously. The number of data sources 525 may depend on the level of resiliency that the system requires to meet a specified business risk tolerance.

The control logic module 515 may retrieve and execute control logic 535 at a operation 530 to set one or more preference timers to allow one of the data sources 525 preferential treatment in some cases. For example, if a preference for data source 1 525A is desired, then a 100 millisecond (ms) preference timer may be set by the control logic module 515 according to the control logic 535, the preference timer indicating that the control logic module 515 should wait 100 ms for all data to be retrieved. If the data source 1 525A responds within that time, the control logic module 515 should use data source 1 525A as a basis for generating its assessment of the user. If data source 1 525 does not respond within 100 ms, then the control logic module 515 should instead use data from data source 2 525B as a basis for generating its assessment of the user.

The control logic module 515, executing the control logic 535, can also detect chronic latency from data sources 525 and adjust the control logic module 515's behavior accordingly. For example, if the preferred data source's response exceeds the retrieval timer X number of times within a configured window, the control logic module 515 may change its the preferred data source to be a different data source, as the previously-preferred data source is unreliable.

The situational awareness service 545 is a service that may also feed information 540 to the control logic module 515, and by extension is utilized by the control logic 535. The situational awareness service 545 reports on the condition of the data sources. For example, the situational awareness service 545 may identify whether data sources 525 are synchronized with one another (e.g., yes or no), what the computational/time cost is of one data source over another, what the quality is of one data source over another, or some combination thereof. The information 540 from the situational awareness service 545 may be used by the control logic module 515 and the control logic 535 to determine whether to prefer one data source 525 over another, and if so, which data source 525 to prefer.

A concluding data message 550 is sent back to the micro-service 505 by the control logic module 515 and/or the control logic 535. The concluding data message 550 may include data from one or more of the data source(s) 525, and may include preference information as to which data to prefer. Alternately, if information from one of the data sources 525 is preferred, information from other data sources may be excluded from the final data message 550.

FIG. 6 is a system architecture block diagram for a data lake system for self-healing micro-services.

A service 605, which may be a micro-service 505 as in FIG. 5 or a service in the domain services layer 120 of FIG. 1, may send a request for information to a data lake system 630 and to a second data source 625. These requests may be sent in parallel or sequentially in either order. The data lake system 630 may include a primary data source 620 that may be a higher priority data source than the second data source 625, for instance because it is a more direct and/or reputable source (e.g., it is provided by an organization that is an authority on or original source of this type of data), a more verifiable data source, a more secure data source, a more up-to-date source of data, or some combination thereof. The second data source 625 may include data that has been backed up from the primary data source 620 periodically, but may be less up-to-date, direct, reputable, verifiable, and/or secure due to it being a backup rather than straight from the organization that is considered an authority on or original source of this type of data. For instance, the data lake system 630 may provide a FICO® score straight from a credit agency, while the second data source 625 may provide a backup of a FICO® score that was received relatively recently from the credit agency.

The data lake system 630 may receive the request through a data security layer 610, which may include a firewall and/or a data tokenization system. A data lake application programming interface (API) 615 may be used to submit the request to a primary data source 620 in the data lake system 630. In some cases, the primary data source 620 in the data lake system 630 may respond to the service 605 with information responsive to the request. In some cases, the primary data source 620 in the data lake system 630 may perform a one-way replication of at least a subset of its data (e.g., the data corresponding to that request and/or response) by sending that data to a second data source 625, which may in some cases be located in a different location than the primary data source 620 so as to provide a safe backup in case of natural disaster or simple network latency.

If the service 605 receives a response from the primary data source 620 within an amount of time necessary (e.g., before the timer of the operations 300 expires), then the service 605 may use the data from the primary data source 620 to generate an assessment. If the service 605 does not receive a response from the primary data source 620 of the data lake system 630 within the amount of time necessary (e.g., before the timer of the operations 300 expires) for one reason or another (e.g., server downtime, natural disaster, etc.), the service 605 may instead use data received by the service 605 from the second data source 625. In this way, relatively up-to-date data may be provided in a timely fashion even if the primary data source is slow or sometimes unreliable. If the primary data source 620 becomes regularly slow or unreliable, then the secondary data source 625 can become a primary data source 620, and the primary data source 620 can be demoted to second data source 625 status.

In some cases, the request to the second data source 625 is sent directly from the service 605 to the second data source 625. In other cases, the request to the second data source 625 is sent from the service 605 to at least part of the data lake system 630, such as the data lake API 615, which may then forward the request on to the second data source 625 if the primary data source 620 is not responsive. In this way, the service 605 needs only to send one request to the data lake system 630, simplifying its work, and the data lake system 630 may handle further forwarding of the request to the primary data source 620 and the second data source 625. In some cases, requests may be sent from the service 605 and/or the data late system 630 to a third data source, fourth data source, or even more data sources to increase the odds that at least one of the data sources will be up and able to provide the requested data within the time allotted (e.g. before the timer expires).

FIG. 7 is a flow diagram illustrating operations 700 for dynamic timed decisioning. The operations 700 of FIG. 7 are performed by a dynamic timed decisioning system. The dynamic timed decisioning system may be, and/or may include, the computing system 105 of FIG. 1, the data lake system 130 of FIG. 1, the user assessment and decisioning system of FIG. 2, the dynamic timed decisioning system of FIG. 3, the data lake system of FIG. 4, the user assessment and decisioning system of FIG. 5, the data latke system of FIG. 6, the user assessment and decisioning system 800 of FIG. 8, the user assessment and decisioning system 900 of FIG. 9, the computing device 1000 of FIG. 10, or a combination thereof.

At operation 705, the dynamic timed decisioning system receives, from a client terminal, a request for an assessment of a user. The client terminal can include, for example, the client terminal 190 of FIG. 1, the requesting node 205 of FIG. 2, the terminal of operation 305 and 345, a user device associated with the user, a merchant device associated with a merchant, a financial institution device associated with a financial institution, a credit institution device associated with a credit institution, or a combination thereof. The request for the assessment of the user may be received based on the user requesting a transaction, such as one or more purchases by the user from the entity, rentals by the user from the entity, applications for credit (e.g., for a new line of credit, a new loan, a new credit card) by the user from the entity, changes to credit (e.g., requesting a credit limit increase or other adjustment to a line of credit) by the user from the entity, or a combination thereof. Operations 305 and/or 920 may be examples of operation 705, and vice versa.

At operation 710, the dynamic timed decisioning system determines a duration of time available for responding to the request. In some examples, the request for the assessment of the user may itself identify the duration of time available for responding to the request, or may be sent along with other data identifying the duration of time available for responding to the request, in which case determines the duration of time may include parsing the duration of time from the request for the assessment of the user or from the other data identifying the duration of time.

At operation 715, the dynamic timed decisioning system starts a timer in response to receiving the request. The timer may be the timer of FIG. 2 and/or the timer of FIG. 3. The timer may start from the time of receipt of the request for the assessment of the user. The timer may start from the time of transmission of the request for the assessment of the user. The timer may start a time at which one of the operations 705-735 occurs, begins, or completes. Operation 310 may be an example of operation 715, or vice versa.

At operation 720, the dynamic timed decisioning system transmits a plurality of requests for information about the user to one or more data sources. The plurality of requests for information can include at least a first request and a second request. In some cases, the requests may be referred to as queries, and transmitting the requests may be referred to as querying a data source. The one or more communications 270 to the various data services 275 of FIG. 2 may be examples of the plurality of requests for information about the user transmitted to the one or more data sources of operation 720. The one or more communications 520 sent to the data source 1 525A and/or the data source 2 525B of FIG. 5 may be examples of the plurality of requests for information about the user transmitted to the one or more data sources of operation 720. The one or more requests sent from the service 605 of FIG. 6 may be examples of the plurality of requests for information about the user transmitted to the one or more data sources of operation 720. Examples of the one or more data sources may include the various data services 275, the data lake system 405, the master dataset 440, the credit grade calculator 445, the data storage 460, the non-monetary dataset 420, the card holder dataset 425, the distributed file system 430, the data source 1 525A, the data source 2 525B, the primary data source 620, the second data source 625, the data lake system 630, the data lake 930, or a combination thereof. Operation 315 may be an example of operation 720, or vice versa.

In some examples, transmitting the plurality of requests in operation 720 includes transmitting the first request in parallel with transmitting the second request. In some examples, transmitting the plurality of requests in operation 720 includes transmitting the first request before transmitting the second request. In some examples, transmitting the plurality of requests in operation 720 includes transmitting the first request after transmitting the second request

At operation 725, the dynamic timed decisioning system receives a first responsive dataset from the one or more data sources in response to transmission of the first request. The one or more communications 270 from the various data services 275 of FIG. 2 may be examples of responsive datasets such as the first responsive dataset. The one or more communications 520 received from the data source 1 525A and/or the data source 2 525B of FIG. 5 may be examples of the first responsive dataset from the one or more data sources of operation 725. The first dataset of operation 320 may be an example of the first responsive dataset of operation 725, or vice versa. Operation 320 may be an example of operation 725, or vice versa.

At operation 730, the dynamic timed decisioning system determines, based on time still remaining on the timer following receipt of the first responsive dataset and on the duration of time available for responding to the request, that an optimal action for generating the assessment includes waiting for receipt of a second responsive dataset in response to transmission of the second request. The timer may count up or down, and may count as “expired” when the timer has counted a threshold duration of time that is based on the duration of time available for responding to the request. Operation 245 may be an example of operation 730, or vice versa. Operation 325 may be an example of operation 720, or vice versa.

The determination that the optimal action for generating the assessment includes waiting for receipt of a second responsive dataset may be based on a determination that the second responsive dataset includes, is set to include, or is likely to include, information that is important to generate the assessment of the user (e.g., a credit score of the user). The determination that the optimal action for generating the assessment includes waiting for receipt of a second responsive dataset may be based on an estimated time of receipt of the second responsive dataset being soon, for instance before the timer counts the threshold duration of time. The determination that the optimal action for generating the assessment includes waiting for receipt of a second responsive dataset may be based on the second responsive dataset already undergoing receipt operations at the dynamic timed decisioning system at the time of the determination of the optimal action. The determination that the optimal action for generating the assessment includes waiting for receipt of a second responsive dataset may be based on the second responsive dataset being a cached copy (e.g., replicated in the second data source 625) of information that would otherwise be in a third responsive dataset (e.g., from a primary data source 620), where an estimated time of receipt of the third responsive dataset is after the timer counts the threshold duration of time.

In some examples, the optimal action determined in operation 730 includes transmitting the second request of operation 720.

At operation 735, the dynamic timed decisioning system receives the second responsive dataset from the one or more data sources in response to transmission of the second request. The one or more communications 270 from the various data services 275 of FIG. 2 may be examples of responsive datasets such as the second responsive dataset. The one or more communications 520 received from the data source 1 525A and/or the data source 2 525B of FIG. 5 may be examples of the second responsive dataset from the one or more data sources. The second dataset of operation 330 may be an example of the second responsive dataset of operation 735, or vice versa. Operation 330 may be an example of operation 735, or vice versa.

The receipt of the second responsive dataset in operation 735 may be based on the determination, in operation 730, that the optimal action for generating the assessment includes waiting for receipt of the second responsive dataset. For instance, the receipt of the second responsive dataset in operation 735 may be the result of waiting for receipt of the second responsive dataset.

In some examples, receipt of the first responsive dataset occurs at a first time, and receipt of the second responsive dataset occurs at a second time. The second time may be after the first time. The second time may be contemporaneous with the first time.

At operation 740, the dynamic timed decisioning system determines, following receipt of the second responsive dataset, that the timer has counted at least a threshold duration of time. The threshold duration of time is based on the time available for responding to the request. The timer may count up or down, and may count as “expired” when the timer has counted a threshold duration of time that is based on the duration of time available for responding to the request. In some examples, the threshold time is a less than the duration of time available for responding to the request by a difference, with the difference being an amount of time within which the assessment can be generated and sent. Operation 245 may be an example of operation 740, or vice versa. Operation 340 may be an example of operation 740, or vice versa.

In some examples, the threshold duration of time is the duration of time available for responding to the request minus a predetermined assessment duration of time. The predetermined assessment duration of time can be a predetermined amount of time for generating and/or sending the assessment as in operations 745 and/or 750. In some examples, the threshold duration of time is a predetermined percentage of the duration of time available for responding to the request. A remaining percentage of the duration of time available for responding to the request can be an assessment duration of time for generating and/or sending the assessment as in operations 745 and/or 750.

At operation 745, the dynamic timed decisioning system generates the assessment of the user based on the first responsive dataset and the second responsive dataset based on the timer having counted at least the threshold duration of time. The credit grade generated by the credit grade calculator 445 may be an example of the assessment of operation 745. The assessment generated at the generate assessment operation 870 of FIGS. 8 and/or 9 may be examples of the assessment of operation 745. The decision generated at the decisioning operation 875 of FIGS. 8 and/or 9 be examples of the assessment of operation 745. Operation 335 may be an example of operation 745, or vice versa.

At operation 750, the dynamic timed decisioning system transmits the assessment of the user to the client terminal based on timer having counted at least the threshold duration of time. The transmission of the assessment and/or decision operation 950 of FIG. 9 may be an example of the transmission of the assessment of the user to the client terminal of operation 750. Operation 345 may be an example of operation 750, or vice versa.

In some examples generating the assessment in operation 745 includes generating a grade corresponding to a level of risk associated with the user. The grade can be within a range of possible grades. The grade corresponding to the level of risk associated with the user can correspond to a creditworthiness of the user. For example, the grade corresponding to the level of risk associated with the user can be the credit grade generated by the credit grade calculator 445 of FIG. 4. The assessment generated in operation 745 can include the grade corresponding to the level of risk associated with the user.

In some examples, the dynamic timed decisioning system determines that the grade exceeds a predetermined grade threshold, and the assessment includes a recommendation based on determining that the grade exceeds the predetermined grade threshold. The recommendation can be a recommendation to approve the user for at least one of a new credit account or a credit limit increase based on determining that the grade exceeds the predetermined grade threshold. In some examples, the dynamic timed decisioning system determines that the grade is less than a predetermined grade threshold, and the assessment includes a recommendation based on determining that the grade is less than the predetermined grade threshold. The recommendation can be a recommendation to decline the user for at least one of a new credit account or a credit limit increase.

In some examples, the dynamic timed decisioning system receives a third responsive dataset from the one or more data sources in response to transmission of a third request and after the timer has counted at least the threshold duration of time. The plurality of requests for information include the third request The one or more communications 270 from the various data services 275 of FIG. 2 may be examples of responsive datasets such as the third responsive dataset. The one or more communications 520 received from the data source 1 525A and/or the data source 2 525B of FIG. 5 may be examples of the third responsive dataset from the one or more data sources. In some examples, the assessment is generated without use of the third responsive dataset in response to receipt of the third responsive dataset after the timer has counted at least the threshold duration of time.

In some examples, the dynamic timed decisioning system receives a third responsive dataset from the one or more data sources in response to transmission of a third request and b the timer has counted at least the threshold duration of time. The plurality of requests for information include the third request The one or more communications 270 from the various data services 275 of FIG. 2 may be examples of responsive datasets such as the third responsive dataset. The one or more communications 520 received from the data source 1 525A and/or the data source 2 525B of FIG. 5 may be examples of the third responsive dataset from the one or more data sources. In some examples, the assessment is generated based also on the third responsive dataset in response to receipt of the third responsive dataset before the timer has counted at least the threshold duration of time.

In some examples, the first responsive dataset and the second responsive dataset are part of a plurality of responsive datasets. The plurality of responsive datasets can include a Fair Isaac Corporation (FICO)® score. The assessment generated in operation 745 may be generated based on the FICO® score.

In some examples, the first responsive dataset and the second responsive dataset are part of a plurality of responsive datasets. The plurality of responsive datasets can identify, include, or be indicative of a change in a property of the user. The assessment generated in operation 745 may be generated based on the change in the property of the user. The change in the property of the user may include at least one of a change in a marriage status of the user, a change in an employment status of the user, a change in a dependent status of the user, a change in an address of the user, a change in a name of the user (e.g., a change in a surname due to marriage or other reasons), or a combination thereof.

In some examples, the first responsive dataset and the second responsive dataset are part of a plurality of responsive datasets. The plurality of responsive datasets can identify, include, or be indicative of a plurality of changes in a parameter associated with the user over an assessed period of time. The assessment generated in operation 745 may be generated based on the plurality of changes in the parameter associated with the user over the assessed period of time. Examples of this assessing of a parameter over a period of time are discussed herein with respect to the data lake system 405, the account event processor 435, the rules configuration 450, and/or the credit grade calculator 445 of FIG. 4. In some examples, the dynamic timed decisioning system determines a trajectory of values for the parameter over the assessed period of time based on the plurality of changes in the parameter over the assessed period of time, and the assessment is generated based on the trajectory of values for the parameter over the assessed period of time. Examples of this assessing a trajectory of a parameter over a period of time are discussed herein with respect to the data lake system 405, the account event processor 435, the rules configuration 450, and/or the credit grade calculator 445 of FIG. 4. In some examples, the dynamic timed decisioning system determines a sum of the plurality of changes in the parameter associated with the user over the assessed period of time, wherein the assessment is generated based on a comparison between the sum and a threshold value. Examples of this assessing of a parameter based on a sum over a period of time are discussed herein with respect to the data lake system 405, the account event processor 435, the rules configuration 450, and/or the credit grade calculator 445 of FIG. 4.

In some examples, the dynamic timed decisioning system generates the assessment of the user based on a set of rules. The set of rules can include, for example, the rules of the rules engine of FIG. 1, the rules of the rules engine 235, the rules of the rules configuration 450 of FIG. 4, the user-based rules 850 of FIGS. 8-9, the transaction-based rules 855 of FIGS. 8-9, the fraud detection rules 860 of FIGS. 8-9, or a combination thereof. The dynamic timed decisioning system can apply the set of rules, for example by comparing thresholds and/or ranges identified in the set of rules to information in the first responsive dataset, information in the second responsive dataset, information in a third responsive dataset, or a combination thereof.

In some examples, the dynamic timed decisioning system performs a combination of one or more operations illustrated in or discussed with respect to in FIG. 1, one or more operations illustrated in or discussed with respect to in FIG. 2, one or more operations illustrated in or discussed with respect to the operations 300 of FIG. 3, one or more operations illustrated in or discussed with respect to FIG. 4, one or more operations illustrated in or discussed with respect to FIG. 5, one or more operations illustrated in or discussed with respect to FIG. 6, one or more operations illustrated in or discussed with respect to the operations 700 of FIG. 7, one or more operations illustrated in or discussed with respect to FIG. 8, one or more operations illustrated in or discussed with respect to FIG. 9, one or more operations illustrated in or discussed with respect to FIG. 10, or a combination thereof.

Technical improvements provided by a dynamic timed decisioning system as described herein may include, for example, improved efficiency in generating and providing an assessment, for example based on determination of optimal actions for generating the assessment within a duration of time available for responding to the request (see at least operations 705, 710, 730, 325, 335). Technical improvements also include increased reliability in providing the assessment, since the duration of time available for responding to the request is adhered to and the dynamic timed decisioning system flexibly handles issues such as nonresponsive data sources without sacrificing provision of the assessment in a timely manner. The efficiency and reliability here also does not sacrifice security, as discussed herein with respect to fraud detection rules 860 for example, and allows the analysis for the assessment generated by the dynamic timed decisioning system to be as thorough as possible given the duration of time available for responding to the request. Further technical improvements include increased efficiency and reliability for client devices that send the request for the assessment of the user and that receive the assessment of the user from the dynamic timed decisioning system. Because these client devices can perform transactions such as providing users with credit cards or lines of credit, the technical improvements to the dynamic timed decisioning system mean improvements to the efficiency and reliability of systems for provision of credit cards, lines of credit, or other transactions.

FIG. 8 is a block diagram illustrating a system architecture of a user assessment and decisioning system 800 with an analysis engine 805, a choreography engine 815, and a strategy engine 845. The user assessment and decisioning system 800 includes an analysis engine 805. The analysis engine 805 may include one or more computing system 1000.

The user assessment and decisioning system 800 receives a request for an assessment of a user. For example, the request for the assessment of the user can be received from a merchant device of a merchant who is requesting the assessment of the user before initiating and/or completing a transaction between the merchant and the user, from a credit institution device of a credit institution (e.g., credit card processors, credit card issuers, credit bureaus, lenders, credit owners) who is requesting the assessment of the user before initiating and/or completing a transaction between the credit institution and the user, from a financial institution device of a financial institution (e.g., banks, credit unions, lenders) who is requesting the assessment of the user before initiating and/or completing a transaction between the financial institution and the user. Examples of transactions between the user and an entity (e.g., a merchant, a credit institution, or a financial institution) with may include purchases by the user from the entity, rentals by the user from the entity, applications for credit (e.g., for a new line of credit, a new loan, a new credit card) by the user from the entity, changes to credit (e.g., requesting an credit limit increase or other adjustment to a line of credit) by the user from the entity, or a combination thereof.

The analysis engine 805 initiates and/or performs a preliminary analysis 810. The preliminary analysis 810 can include various checks of information supplied as part of the request and/or as part of the transaction. The checks performed by the preliminary analysis 810 can verify whether the user is eligible and/or authorized to make the transaction. For example, the preliminary analysis 810 can verify whether the user's age meets or exceeds a threshold age required for or otherwise corresponding to the transaction, such as 13, 14, 15, 16, 17, 18, 19, 20, 21, 22, 23, 24, 25, 26, 27, 28, 29, 30, or another threshold age. The checks performed by the preliminary analysis 810 can verify whether all information required to complete the transaction is received and is in the correct format. For example, if the transaction requires or otherwise corresponds to a form to be filled out, the checks performed by the preliminary analysis 810 can verify whether all of the fields in the form are filled in, and/or can verify whether all of the fields in the form are filled in with the correct type of information, or both. For instance, the preliminary analysis 810 can verify whether a “zip code” field is filled out and includes a 5-digit number, a “name” field is filled out and includes a string of text, a “birth date” field is filled out and includes enough digits of a number to form a date, a “social security number” field is filled out and includes a 9-digit number, and so forth. The checks performed by the preliminary analysis 810 can verify whether certain action required to complete the transaction, or otherwise corresponding to the transaction, have been performed. For example, if the transaction requires the user to pay a fee, the checks performed by the preliminary analysis 810 can verify, based on a fee payment history of the user and/or a fee receipt history (e.g., of the entity), whether the user has paid the fee.

The user assessment and decisioning system 800 includes a choreography engine 815, which can perform one or more additional analyses and one or more tasks associated with the preliminary analysis 810, the strategic analysis 840, or both. The choreography engine 815 can be used, for example, to set a unique identifier 820 for each user for which an assessment is requested and/or for which data is otherwise present. The unique identifier 820 can be generated to be truly unique. Setting a unique identifier 820 and associating assessments and data with the unique identifier 820 can provide a technical benefit over use of certain identifiers such as social security number (SSN) for this purpose, as malicious parties may attempt fraudulent activities by using another person's SSN or other information. Setting of, and use of, the unique identifier 820 can prevent such fraudulent activity from affecting the actual owner of the SSN.

The choreography engine 815 can perform a duplicate check 825. The duplicate check 825 can detect whether the request for the assessment, the transaction, or both are duplicates. If so, the choreography engine 815 can discard one of the requests for assessment and/or one of the transactions. For example, the duplicate check 825 can check whether more than one identical (or very similar with only minor differences such as metadata) credit line applications for a user have been received, and/or whether more than one identical (or very similar with only minor differences such as metadata) requests for assessment of the same user corresponding to the credit line applications have been received. Such duplicates may have been submitted erroneously, and discarding one or more so that only one is left can ensure that, for example, the entity does not open two or more lines of credit for the user when the user only wished to open one line of credit. In some examples, a request for confirmation can be sent to the user and/or the entity to verify whether a duplicate can be removed, and/or whether a duplicate was intended, to allow processing of duplicate actions if they are indeed intended. The duplicate check 825 can also be used to check for certain types of fraud, such as brute force attacks by a malicious party, in which much of the information submitted for a transaction by or on behalf of the malicious party may be identical but one or more fields (e.g., password, username, SSN) may change as a malicious party attempts to find a combination of information that works.

The choreography engine 815 can include a data service 830. The data service 830 can obtain, receive, retrieve, provide, and/or transmit information about the user. In some examples, the data service 830 can be queried by the entity (e.g., by the merchant, financial institution, credit institution, or any other type of entity described above) using a first set of one or more pieces of information about the user, such as the user's name, date of birth, username, password, unique identifier 820, credit card number, bank account number, email address, mailing address, residence address, billing address, SSN, other information about a user discussed herein, or a combination thereof. In response to the query, the data service 830 can retrieve a second set of one or more pieces of information about the user from one or more data sources, and can provide the second set of one or more pieces of information about the user to the entity. The second set of one or more pieces of information about the user can include, for example, the user's name, date of birth, username, password, unique identifier 820, credit card number, bank account number, email address, mailing address, residence address, billing address, SSN, other information about a user discussed herein, or a combination thereof.

The choreography engine 815 can include a bureau service 835. The bureau service 835 can communicate with one or more credit bureaus. The bureau service 835 can send an identifier of the user to a bureau device associated with a credit bureau. The identifier of the user can be, for example, the user's name, date of birth, username, password, unique identifier 820, credit card number, bank account number, email address, mailing address, residence address, billing address, SSN, other information about a user discussed herein, or a combination thereof. The bureau device can identify a credit score for the user, and can send the credit score for the user to the bureau service 835 in response to receipt of the identifier of the user at the bureau device. The bureau device can identify the credit score for the user using a hard credit check, a soft credit check, or some combination thereof. In some examples, the bureau service 835 can retrieve a cached version of the credit score for the user instead of, or in addition to, obtaining the credit score for the user from the bureau device. For instance, hard credit checks can in some cases impact a user's credit score if they are performed too often in succession, and the cached version of the credit score can be retrieved and/or used if a recent credit check was performed in order to avoid impacting the user's credit score further. In some cases, the cached version of the credit score can be retrieved and/or used if the bureau device is not responding with the credit score quickly enough (e.g., based on an amount of elapsed time since an assessment of the user was requested approaching a duration of time available for the analysis engine to generate and provide its assessment of the user). In some examples, the credit score may be a FICO® credit score.

The choreography engine 815 can provide any information it obtains, such as the unique identifier 820, a determination by the duplicate check 825 as to whether a request/application/transaction is a duplicate, information about the user from the data service 830, and/or credit scores from the bureau service 835, to the preliminary analysis 810 and/or to the strategic analysis 840.

If the one or more checks and analyses that are part of the preliminary analysis 810 and/or choreography engine 815 successfully verify that the user is authorized to make the transaction (and/or fail to identify anything disqualifying the user from authorization to make the transaction), the analysis engine 805 can proceed to a strategic analysis 840.

If the one or more checks and analyses that are part of the preliminary analysis 810 and/or choreography engine 815 fail to verify that the user is authorized to make the transaction (and/or successfully identify something disqualifying the user from authorization to make the transaction), the analysis engine 805 can proceed to generating an assessment 870 and/or decisioning 875, with the assessment and/or decision recommending that the user be declined for the requested transaction. This way, more resource-intensive analyses, such as some of those that may be performed as part of the strategic analysis 840 and/or the strategy engine 845, can be bypassed if the preliminary analysis 810 and/or choreography engine 815 already disqualify the user.

The strategic analysis 840 can include some further fraud detection and/or fraud protection analyses. For example, the strategic analysis 840 can include a 2-factor authentication or 3-factor authentication interface, in which the user and/or entity can be required to provide an authentication code from another device, such as a mobile handset. The strategic analysis 840 can be supported by the strategy engine 845. The strategy engine 845 can include user-based rules 850, request-based rules 855, and fraud detection rules 860.

In some examples, the choreography engine 815 and the strategy engine 845 can be coupled using data caching and sharing 865. For instance, the chorography engine 815 can share information with the strategy engine 845 by sending the information to the strategy engine 845 and/or by caching the information in a data structure accessible to the strategy engine 845. In some cases, the strategy engine 845 can share information with the choreography engine 815 by sending the information to the choreography engine 815 and/or by caching the information in a data structure accessible to the choreography engine 815. In some examples, caching the information may be performed using replication of data in a data source, for instance as in the one-way replication of data from the primary data source 620 to the second data source 625 of FIG. 6.

The user-based rules 850 are related to the user themselves. Examples of the user-based rules 850 include checking whether the user is bankrupt or not, whether the user was recently bankrupt or not, whether the user is deceased or living, whether the user's file has been frozen, whether queries for information about the user result in errors or “no hit” responses, whether the user's credit score exceeds a particular threshold or not, whether a slope of a trajectory the user's credit score over time exceeds a particular threshold or not, which age group the user's age falls into, whether the user's aggregate credit limit (e.g., over one or more credit cards and/or lines of credit) exceeds a threshold, whether the number credit cards and/or lines of credit that the user has exceeds a threshold, whether the number credit cards that the user has and that are associated with a particular brand or merchant exceeds a threshold, other rules related to the user themselves, or a combination thereof.

The request-based rules 855 are related to the transaction that is being requested. For instance, if the transaction is that the user is applying for a credit card, the request-based rules 855 may be rules associated with eligibility for that particular credit card and/or related credit cards. Examples of the request-based rules 855 may include indications that, if a user does not meet certain requirements (e.g., a credit score threshold), a different credit card may be offered to the user instead of the one requested. For example, if the user is applying for a dual card (DC) but is not eligible, then a private label credit card (PLCC) may be offered in place of the dual card. This offering of a different credit card or other credit product may be referred to as downselling. If the transaction is that the user is applying for a line of credit, the request-based rules 855 may be rules associated with eligibility for that particular line of credit and/or related lines of credit.

The fraud detection rules 860 may be specific to detection of fraud or likely fraud attempts. The fraud detection rules 860 may automatically identify certain types of fraud, such as brute force attacks in which many similar transaction requests are submitted sequentially with small changes in an attempt by a malicious party to find a combination that works. In some examples, the fraud detection rules 860 may be used to check whether a transaction request is coming from a geographical location that would be unusual for the user to be requesting such a transaction from, for example from another country or continent than the user is in. In some examples, the fraud detection rules 860 may request fraud checks from third parties that may perform, for example, background checks on a user.

In some examples, any one of the user-based rules 850, the transaction-based rules 855, and/or the fraud detection rules 860 can include any one or more rules discussed with respect to the rules of the rules engine of FIG. 1, the rules of the rules engine 235, the rules of the rules configuration 450 of FIG. 4, the user-based rules 850 of FIGS. 8-9, the transaction-based rules 855 of FIGS. 8-9, the fraud detection rules 860 of FIGS. 8-9, or a combination thereof.

The information determined by the preliminary analysis 810, the choreography engine 815, the strategic analysis 840, and/or the strategy engine 845 may feed in to generating an assessment 870 of the user. The assessment of the user may include, for example, a grade for the user as discussed herein. In some examples, the assessment of the user may be used in decisioning 875 to make a decision as to whether to recommend accepting or declining the transaction for the user (e.g., whether to recommend granting or declining a requested line of credit for the user). For example, if the grade exceeds a certain transaction-specific threshold (e.g., noted in the transaction-based rules 855), the decision may be to grant the transaction, and otherwise the decision may be to decline the transaction. In some examples, the assessment of the user may include a decision (e.g., as to whether to recommend accepting or declining the transaction for the user), in which case generating the assessment 870 may be part of decisioning 875.

FIG. 9 is a block diagram illustrating a system architecture of a user assessment and decisioning system 900 with a communication system 905, an analysis system 910, and a strategy system 915. The communication system 905, the analysis system 910, and the strategy system 915 may each include one or more computing systems 1000.

At operation 920, the communication system 905 receives, from a user device or a device associated with an entity (e.g., a merchant, a financial institution, and/or a credit institution), a request for an assessment of the user 920. The request for the assessment of the user 920 may be received based on the user requesting a transaction, such as one or more purchases by the user from the entity, rentals by the user from the entity, applications for credit (e.g., for a new line of credit, a new loan, a new credit card) by the user from the entity, changes to credit (e.g., requesting a credit limit increase or other adjustment to a line of credit) by the user from the entity, or a combination thereof. The requested assessment may take the form of a recommendation as to whether or not to approve the transaction, and/or may include information (e.g., a grade for the user) based on which the entity can more efficiently decide whether or not to approve the transaction. In some cases, the request for the assessment of the user 920 can identify a duration of time available to the user assessment and decisioning system 900 to respond to the request for the assessment of the user 920 (e.g., with the requested assessment of the user).

In response to the request for the assessment of the user 920, the analysis system 910 can perform the preliminary analysis 810. The preliminary analysis 810 can include use of the choreography engine 815. The choreography engine 815 can be on the analysis system 910, on the strategy system 915, or partially on both. As discussed with respect to FIG. 8, the choreography engine 815 can set a unique identifier 820 for the user, perform the duplicate check 825, retrieve data as a data service 830, and communicate with one or more credit bureaus as the bureau service 835. In some examples, the bureau service 835 can communicate with the one or more credit bureaus through a bureau communication link 925 of the communication system 905.

The analysis system 910 can also perform the strategic analysis 840. The strategic analysis 840 can include use of the strategy engine 845. The strategy engine 845 can be on the analysis system 910, on the strategy system 915, or partially on both. As discussed with respect to FIG. 8, the strategy engine 845 can include, and perform analyses based on, user-based rules 850, transaction-based rules 855, and/or fraud detection rules 860. In some examples, any one of the user-based rules 850, the transaction-based rules 855, and/or the fraud detection rules 860 can include any one or more rules discussed with respect to the rules of the rules engine of FIG. 1, the rules of the rules engine 235, the rules of the rules configuration 450 of FIG. 4, the user-based rules 850 of FIGS. 8-9, the transaction-based rules 855 of FIGS. 8-9, the fraud detection rules 860 of FIGS. 8-9, or a combination thereof.

In some examples, the strategy system 915 may include a machine learning (ML) engine 940. The ML engine 940 may include one or more artificial intelligence algorithms, one or more trained machine learning (ML) models trained using training data and generated based on one or more ML algorithms, one or more trained neural networks (NNs) trained using training data, or some combination thereof. The analysis system 910 can craft an ML input 935 as part of the strategic analysis 840, the strategy engine 845, and/or generation of the assessment 865. The ML input 935 may, for example, provide a predetermined set of one or more types of information about a user. For example, the ML input 935 may include the user's name, date of birth, username, password, unique identifier 820, credit card number, bank account number, email address, mailing address, residence address, billing address, SSN, other information about a user discussed herein, or a combination thereof. ML input 935 may include information about past assessments, requests for assessments, transactions, requests for transactions, decisions regarding those transactions, or combinations thereof. The ML engine 940 can generate an ML output 945, which the analysis system 910 can receive, parse, and/or interpret. For example, the ML engine 940 can be trained to estimate a user's eligibility for a transaction as its ML output 945 based on the ML input 935. Such training can be done based on training data with eligibility decisions for multiple users for the transactions of the same type alongside similar input information. The ML engine 940 can be trained to identify fraudulent activity as its ML output 945 based on the ML input 935. Such training can be done based on training data within which activities are tagged as fraudulent or not based on similar input information. The ML engine 940 can be trained to estimate an assessment 865 as its ML output 945 based on the ML input 935. Such training can be done based on training data within which assessments are identified based on similar input information.

The choreography engine 815 and the strategy engine 845 can share information through data caching and sharing 865 as discussed with respect to FIG. 860. The strategy system 915 may include a data lake 930, which may include aspects of the data lake systems of FIGS. 4 and/or 6. The data lake 930 can be accessed by, and/or interacted with, by the choreography engine 815 and/or the strategy engine 845.

The analysis system 910 can generate the assessment 870. The information determined by the preliminary analysis 810, the choreography engine 815, the strategic analysis 840, and/or the strategy engine 845 may feed in to generating an assessment 870 of the user. The information from the ML output 945 and/or the data lake 930 can feed in to generating an assessment 870 of the user. The assessment of the user may include, for example, a grade for the user as discussed herein. In some examples, the assessment of the user may be used in decisioning 875 to make a decision as to whether to recommend accepting or declining the transaction for the user (e.g., whether to recommend granting or declining a requested line of credit for the user). For example, if the grade exceeds a certain transaction-specific threshold (e.g., noted in the transaction-based rules 855), the decision may be to grant the transaction, and otherwise the decision may be to decline the transaction. Decisioning 875 may occur on the analysis system 910, the communication system 905 (e.g., which may perform decisioning 875 with a merchant device, financial institution device, or credit institution device), or a combination thereof. In some examples, the assessment of the user may include a decision (e.g., as to whether to recommend accepting or declining the transaction for the user), in which case generating the assessment 870 may be part of decisioning 875. At operation 950, the communication system 905 may transmit the assessment and/or the decision to one or more recipient devices, such as a user device associated with the user, a merchant device associated with a merchant, a financial institution device associated with a financial institution, a credit institution device associated with a credit institution, or a combination thereof.

FIG. 10 illustrates an exemplary computing system 1000 that may be used to implement some aspects of the technology. For example, any of the computing devices, computing systems, network devices, network systems, servers, and/or arrangements of circuitry described herein may include at least one computing system 1000, or may include at least one component of the computer system 1000 identified in FIG. 10. The computing system 1000 of FIG. 10 includes one or more processors 1010 and memory 1020. Each of the processor(s) 1010 may refer to one or more processors, controllers, microcontrollers, central processing units (CPUs), graphics processing units (GPUs), arithmetic logic units (ALUs), accelerated processing units (APUs), digital signal processors (DSPs), application specific integrated circuits (ASICs), field-programmable gate arrays (FPGAs), or combinations thereof. Each of the processor(s) 1010 may include one or more cores, either integrated onto a single chip or spread across multiple chips connected or coupled together. Memory 1020 stores, in part, instructions and data for execution by processor 1010. Memory 1020 can store the executable code when in operation. The system 1000 of FIG. 10 further includes a mass storage device 1030, portable storage medium drive(s) 1040, output devices 1050, user input devices 1060, a graphics display 1070, and peripheral devices 1080.

The components shown in FIG. 10 are depicted as being connected via a single bus 1090. However, the components may be connected through one or more data transport means. For example, processor unit 1010 and memory 1020 may be connected via a local microprocessor bus, and the mass storage device 1030, peripheral device(s) 1080, portable storage device 1040, and display system 1070 may be connected via one or more input/output (I/O) buses.

Mass storage device 1030, which may be implemented with a magnetic disk drive or an optical disk drive, is a non-volatile storage device for storing data and instructions for use by processor unit 1010. Mass storage device 1030 can store the system software for implementing some aspects of the subject technology for purposes of loading that software into memory 1020.

Portable storage device 1040 operates in conjunction with a portable non-volatile storage medium, such as a floppy disk, compact disk or Digital video disc, to input and output data and code to and from the computer system 1000 of FIG. 10. The system software for implementing aspects of the subject technology may be stored on such a portable medium and input to the computer system 1000 via the portable storage device 1040.

The memory 1020, mass storage device 1030, or portable storage 1040 may in some cases store sensitive information, such as transaction information, health information, or cryptographic keys, and may in some cases encrypt or decrypt such information with the aid of the processor 1010. The memory 1020, mass storage device 1030, or portable storage 1040 may in some cases store, at least in part, instructions, executable code, or other data for execution or processing by the processor 1010.

Output devices 1050 may include, for example, communication circuitry for outputting data through wired or wireless means, display circuitry for displaying data via a display screen, audio circuitry for outputting audio via headphones or a speaker, printer circuitry for printing data via a printer, or some combination thereof. The display screen may be any type of display discussed with respect to the display system 1070. The printer may be inkjet, laserjet, thermal, or some combination thereof. In some cases, the output device circuitry 1050 may allow for transmission of data over an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. Output devices 1050 may include any ports, plugs, antennae, wired or wireless transmitters, wired or wireless transceivers, or any other components necessary for or usable to implement the communication types listed above, such as cellular Subscriber Identity Module (SIM) cards.

Input devices 1060 may include circuitry providing a portion of a user interface. Input devices 1060 may include an alpha-numeric keypad, such as a keyboard, for inputting alpha-numeric and other information, or a pointing device, such as a mouse, a trackball, stylus, or cursor direction keys. Input devices 1060 may include touch-sensitive surfaces as well, either integrated with a display as in a touchscreen, or separate from a display as in a trackpad. Touch-sensitive surfaces may in some cases detect localized variable pressure or force detection. In some cases, the input device circuitry may allow for receipt of data over an audio jack, a microphone jack, a universal serial bus (USB) port/plug, an Apple® Lightning® port/plug, an Ethernet port/plug, a fiber optic port/plug, a proprietary wired port/plug, a wired local area network (LAN) port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, personal area network (PAN) signal transfer, wide area network (WAN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. Input devices 1060 may include any ports, plugs, antennae, wired or wireless receivers, wired or wireless transceivers, or any other components necessary for or usable to implement the communication types listed above, such as cellular SIM cards.

Input devices 1060 may include receivers or transceivers used for positioning of the computing system 1000 as well. These may include any of the wired or wireless signal receivers or transceivers. For example, a location of the computing system 1000 can be determined based on signal strength of signals as received at the computing system 1000 from three cellular network towers, a process known as cellular triangulation. Fewer than three cellular network towers can also be used—even one can be used—though the location determined from such data will be less precise (e.g., somewhere within a particular circle for one tower, somewhere along a line or within a relatively small area for two towers) than via triangulation. More than three cellular network towers can also be used, further enhancing the location's accuracy. Similar positioning operations can be performed using proximity beacons, which might use short-range wireless signals such as BLUETOOTH® wireless signals, BLUETOOTH® low energy (BLE) wireless signals, IBEACON® wireless signals, personal area network (PAN) signals, microwave signals, radio wave signals, or other signals discussed above. Similar positioning operations can be performed using wired local area networks (LAN) or wireless local area networks (WLAN) where locations are known of one or more network devices in communication with the computing system 1000 such as a router, modem, switch, hub, bridge, gateway, or repeater. These may also include Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. Input devices 1060 may include receivers or transceivers corresponding to one or more of these GNSS systems.

Display system 1070 may include a liquid crystal display (LCD), a plasma display, an organic light-emitting diode (OLED) display, a low-temperature poly-silicon (LTPO) display, an electronic ink or “e-paper” display, a projector-based display, a holographic display, or another suitable display device. Display system 1070 receives textual and graphical information, and processes the information for output to the display device. The display system 1070 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 1080 may include any type of computer support device to add additional functionality to the computer system. For example, peripheral device(s) 1080 may include one or more additional output devices of any of the types discussed with respect to output device 1050, one or more additional input devices of any of the types discussed with respect to input device 1060, one or more additional display systems of any of the types discussed with respect to display system 1070, one or more memories or mass storage devices or portable storage devices of any of the types discussed with respect to memory 1020 or mass storage 1030 or portable storage 1040, a modem, a router, an antenna, a wired or wireless transceiver, a printer, a bar code scanner, a quick-response (“QR”) code scanner, a magnetic stripe card reader, a integrated circuit chip (ICC) card reader such as a smartcard reader or a EUROPAY®-MASTERCARD®-VISA® (EMV) chip card reader, a near field communication (NFC) reader, a document/image scanner, a visible light camera, a thermal/infrared camera, an ultraviolet-sensitive camera, a night vision camera, a light sensor, a phototransistor, a photoresistor, a thermometer, a thermistor, a battery, a power source, a proximity sensor, a laser rangefinder, a sonar transceiver, a radar transceiver, a lidar transceiver, a network device, a motor, an actuator, a pump, a conveyer belt, a robotic arm, a rotor, a drill, a chemical assay device, or some combination thereof.

The components contained in the computer system 1000 of FIG. 10 can include those typically found in computer systems that may be suitable for use with some aspects of the subject technology and represent a broad category of such computer components that are well known in the art. That said, the computer system 1000 of FIG. 10 can be customized and specialized for the purposes discussed herein and to carry out the various operations discussed herein, with specialized hardware components, specialized arrangements of hardware components, and/or specialized software. Thus, the computer system 1000 of FIG. 10 can be a personal computer, a hand held computing device, a telephone (“smartphone” or otherwise), a mobile computing device, a workstation, a server (on a server rack or otherwise), a minicomputer, a mainframe computer, a tablet computing device, a wearable device (such as a watch, a ring, a pair of glasses, or another type of jewelry or clothing or accessory), a video game console (portable or otherwise), an e-book reader, a media player device (portable or otherwise), a vehicle-based computer, another type of computing device, or some combination thereof. The computer system 1000 may in some cases be a virtual computer system executed by another computer system. The computer can also include different bus configurations, networked platforms, multi-processor platforms, etc. Various operating systems can be used including Unix®, Linux®, FreeBSD®, FreeNAS®, pfSense®, Windows®, Apple® Macintosh OS® (“MacOS®”), Palm OS®, Google® Android®, Google® Chrome OS®, Chromium® OS®, OPENSTEP®, XNU®, Darwin®, Apple® iOS®, Apple® tvOS®, Apple® watchOS®, Apple® audioOS®, Amazon® Fire OS®, Amazon® Kindle OS®, variants of any of these, other suitable operating systems, or combinations thereof. The computer system 1000 may also use a Basic Input/Output System (BIOS) or Unified Extensible Firmware Interface (UEFI) as a layer upon which the operating system(s) are run.

In some cases, the computer system 1000 may be part of a multi-computer system that uses multiple computer systems 1000, each for one or more specific tasks or purposes. For example, the multi-computer system may include multiple computer systems 1000 communicatively coupled together via at least one of a personal area network (PAN), a local area network (LAN), a wireless local area network (WLAN), a municipal area network (MAN), a wide area network (WAN), or some combination thereof. The multi-computer system may further include multiple computer systems 1000 from different networks communicatively coupled together via the internet (also known as a “distributed” system).

Some aspects of the subject technology may be implemented in an application that may be operable using a variety of devices. Non-transitory computer-readable storage media refer to any medium or media that participate in providing instructions to a central processing unit (CPU) for execution and that may be used in the memory 1020, the mass storage 1030, the portable storage 1040, or some combination thereof. Such media can take many forms, including, but not limited to, non-volatile and volatile media such as optical or magnetic disks and dynamic memory, respectively. Some forms of non-transitory computer-readable media include, for example, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L7), resistive random-access memory (RRAM/ReRAM), phase change memory (PCM), spin transfer torque RAM (STT-RAM), another memory chip or cartridge, or a combination thereof.

Various forms of transmission media may be involved in carrying one or more sequences of one or more instructions to a processor 1010 for execution. A bus 1090 carries the data to system RAM or another memory 1020, from which a processor 1010 retrieves and executes the instructions. The instructions received by system RAM or another memory 1020 can optionally be stored on a fixed disk (mass storage device 1030/portable storage 1040) either before or after execution by processor 1010. Various forms of storage may likewise be implemented as well as the necessary network interfaces and network topologies to implement the same.

While various flow diagrams and block diagrams provided and described above may show a particular order of operations performed by some embodiments of the subject technology, such as the block diagram 200 of FIG. 2, the flow diagram 300 of FIG. 3, the block diagram 400 of FIG. 4, the block diagram 500 of FIG. 5, and the block diagram 600 of FIG. 6, it should be understood that such order is exemplary. Alternative embodiments may perform the operations in a different order, combine certain operations, overlap certain operations, or some combination thereof. It should be understood that unless disclosed otherwise, any process illustrated in any flow diagram herein or otherwise illustrated or described herein may be performed by a machine, mechanism, and/or computing system 1000 discussed herein, and may be performed automatically (e.g., in response to one or more triggers/conditions described herein), autonomously, semi-autonomously (e.g., based on received instructions), or a combination thereof. Furthermore, any action described herein as occurring in response to one or more particular triggers/conditions should be understood to optionally occur automatically response to the one or more particular triggers/conditions.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

Illustrative examples of the disclosure include: Please change the range of the aspects to ensure that the ranges do not cause mutually exclusive embodiments to overlap.

Aspect 1: A method of dynamic timed decisioning, the method comprising: receiving, from a client terminal, a request for an assessment of a user; determining a duration of time available for responding to the request; starting a timer in response to receiving the request; transmitting a plurality of requests for information about the user to one or more data sources, the plurality of requests for information including at least a first request and a second request; receiving a first responsive dataset from the one or more data sources in response to transmission of the first request; determining, based on time still remaining on the timer following receipt of the first responsive dataset and on the duration of time available for responding to the request, that an optimal action for generating the assessment includes waiting for receipt of a second responsive dataset in response to transmission of the second request; receiving the second responsive dataset from the one or more data sources in response to transmission of the second request; determining, following receipt of the second responsive dataset, that the timer has counted at least a threshold duration of time, wherein the threshold duration of time is based on the time available for responding to the request; generating the assessment of the user based on the first responsive dataset and the second responsive dataset based on the timer having counted at least the threshold duration of time; and transmitting the assessment of the user to the client terminal based on timer having counted at least the threshold duration of time.

Aspect 2: The method of Aspect 1, wherein transmitting the plurality of requests includes transmitting the first request in parallel with transmitting the second request.

Aspect 3: The method of any of Aspects 1 to 2, wherein transmitting the plurality of requests includes transmitting the first request before transmitting the second request.

Aspect 4: The method of any of Aspects 1 to 3, wherein the optimal action includes transmitting the second request.

Aspect 5: The method of any of Aspects 1 to 4, wherein transmitting the plurality of requests includes transmitting the first request after transmitting the second request.

Aspect 6: The method of any of Aspects 1 to 5, wherein receipt of the first responsive dataset occurs at a first time, and wherein receipt of the second responsive dataset occurs at a second time after the first time.

Aspect 7: The method of any of Aspects 1 to 6, wherein generating the assessment includes generating a grade corresponding to a level of risk associated with the user, wherein the grade is within a range of possible grades.

Aspect 8: The method of Aspect 7, wherein the grade corresponding to the level of risk associated with the user corresponds to a creditworthiness of the user.

Aspect 9: The method of any of Aspects 7 to 8, wherein the assessment includes the grade.

Aspect 10: The method of any of Aspects 7 to 9, further comprising: determining that the grade exceeds a predetermined grade threshold, wherein the assessment includes a recommendation to approve the user for at least one of a new credit account or a credit limit increase based on determining that the grade exceeds the predetermined grade threshold.

Aspect 11: The method of any of Aspects 7 to 10, further comprising: determining that the grade is less than a predetermined grade threshold, wherein the assessment includes a recommendation to decline the user for at least one of a new credit account or a credit limit increase based on determining that the grade is less than the predetermined grade threshold.

Aspect 12: The method of any of Aspects 1 to 11, further comprising: receiving a third responsive dataset from the one or more data sources in response to transmission of a third request and after the timer has counted at least the threshold duration of time, wherein the plurality of requests for information include the third request, wherein the assessment is generated without use of the third responsive dataset in response to receipt of the third responsive dataset after the timer has counted at least the threshold duration of time.

Aspect 13: The method of any of Aspects 1 to 12, further comprising: receiving a third responsive dataset from the one or more data sources in response to transmission of a third request and before the timer has counted at least the threshold duration of time, wherein the plurality of requests for information include the third request, wherein the assessment is generated based also on the third responsive dataset in response to receipt of the third responsive dataset before the timer has counted at least the threshold duration of time.

Aspect 14: The method of any of Aspects 1 to 13, wherein the threshold duration of time is the duration of time available for responding to the request minus a predetermined assessment duration of time.

Aspect 15: The method of any of Aspects 1 to 14, wherein the threshold duration of time is a predetermined percentage of the duration of time available for responding to the request.

Aspect 16: The method of any of Aspects 1 to 15, wherein a plurality of responsive datasets are received from the one or more data sources in response to transmission of the plurality of requests, wherein the plurality of responsive datasets includes the first responsive dataset and the second responsive dataset, wherein the plurality of responsive datasets includes a Fair Isaac Corporation (FICO)® score, wherein the assessment is generated based on the FICO® score.

Aspect 17: The method of any of Aspects 1 to 16, wherein a plurality of responsive datasets are received from the one or more data sources in response to transmission of the plurality of requests, wherein the plurality of responsive datasets includes the first responsive dataset and the second responsive dataset, wherein the plurality of responsive datasets includes information indicating a change in a property of the user, wherein generating the assessment of the user is based on the change in the property of the user, wherein the property of the user corresponds to one of a marriage status of the user, an employment status of the user, a dependent status of the user, an address of the user, and a name of the user.

Aspect 18: The method of any of Aspects 1 to 17, wherein a plurality of responsive datasets are received from the one or more data sources in response to transmission of the plurality of requests, wherein the plurality of responsive datasets includes the first responsive dataset and the second responsive dataset, wherein the plurality of responsive datasets includes information indicating a plurality of changes in a parameter associated with the user over an assessed period of time, wherein the assessment is generated based on the plurality of changes in the parameter associated with the user over the assessed period of time.

Aspect 19: The method of Aspect 18, further comprising: determining a trajectory of values for the parameter over the assessed period of time based on the plurality of changes in the parameter over the assessed period of time, wherein the assessment is generated based on the trajectory of values for the parameter over the assessed period of time.

Aspect 20: The method of any of Aspects 18 to 19, further comprising: determining a sum of the plurality of changes in the parameter associated with the user over the assessed period of time, wherein the assessment is generated based on a comparison between the sum and a threshold value.

Aspect 21: A system for dynamic timed decisioning, the system comprising: a communication transceiver; a memory storing instructions; and a processor that executes the instructions, wherein execution of the instructions by the processor causes the processor to: receive, from a client terminal at the communication transceiver, a request for an assessment of a user; determine a duration of time available for responding to the request; start a timer in response to receiving the request; transmit a plurality of requests for information about the user to one or more data sources using the communication transceiver, the plurality of requests for information including at least a first request and a second request; receive a first responsive dataset from the one or more data sources at the communication transceiver in response to transmission of the first request; determine, based on time still remaining on the timer following receipt of the first responsive dataset and on the duration of time available for responding to the request, that an optimal action for generating the assessment includes waiting for receipt of a second responsive dataset in response to transmission of the second request; receive the second responsive dataset from the one or more data sources at the communication transceiver in response to transmission of the second request; determine, following receipt of the second responsive dataset, that the timer has counted at least a threshold duration of time, wherein the threshold duration of time is based on the time available for responding to the request; generate the assessment of the user based on the first responsive dataset and the second responsive dataset based on the timer having counted at least the threshold duration of time; and transmit the assessment of the user to the client terminal using the communication transceiver based on timer having counted at least the threshold duration of time.

Aspect 22: The apparatus of Aspect 21, wherein transmitting the plurality of requests includes transmitting the first request in parallel with transmitting the second request.

Aspect 23: The apparatus of any of Aspects 21 to 22, wherein transmitting the plurality of requests includes transmitting the first request before transmitting the second request.

Aspect 24: The apparatus of any of Aspects 21 to 23, wherein the optimal action includes transmitting the second request.

Aspect 25: The apparatus of any of Aspects 21 to 24, wherein transmitting the plurality of requests includes transmitting the first request after transmitting the second request.

Aspect 26: The apparatus of any of Aspects 21 to 25, wherein receipt of the first responsive dataset occurs at a first time, and wherein receipt of the second responsive dataset occurs at a second time after the first time.

Aspect 27: The apparatus of any of Aspects 21 to 26, wherein, to generate the assessment, the processor generates a grade corresponding to a level of risk associated with the user, wherein the grade is within a range of possible grades.

Aspect 28: The apparatus of Aspect 27, wherein the grade corresponding to the level of risk associated with the user corresponds to a creditworthiness of the user.

Aspect 29: The apparatus of any of Aspects 27 to 28, wherein the assessment includes the grade.

Aspect 30: The apparatus of any of Aspects 27 to 29, wherein execution of the instructions by the processor further causes the processor to: determine that the grade exceeds a predetermined grade threshold, wherein the assessment includes a recommendation to approve the user for at least one of a new credit account or a credit limit increase based on determining that the grade exceeds the predetermined grade threshold.

Aspect 31: The apparatus of any of Aspects 27 to 30, wherein execution of the instructions by the processor further causes the processor to: that the grade is less than a predetermined grade threshold, wherein the assessment includes a recommendation to decline the user for at least one of a new credit account or a credit limit increase based on determining that the grade is less than the predetermined grade threshold.

Aspect 32: The apparatus of any of Aspects 21 to 11, wherein execution of the instructions by the processor further causes the processor to: receive a third responsive dataset from the one or more data sources in response to transmission of a third request and after the timer has counted at least the threshold duration of time, wherein the plurality of requests for information include the third request, wherein the assessment is generated without use of the third responsive dataset in response to receipt of the third responsive dataset after the timer has counted at least the threshold duration of time.

Aspect 33: The apparatus of any of Aspects 21 to 32, wherein execution of the instructions by the processor further causes the processor to: receive a third responsive dataset from the one or more data sources in response to transmission of a third request and before the timer has counted at least the threshold duration of time, wherein the plurality of requests for information include the third request, wherein the assessment is generated based also on the third responsive dataset in response to receipt of the third responsive dataset before the timer has counted at least the threshold duration of time.

Aspect 34: The apparatus of any of Aspects 21 to 33, wherein the threshold duration of time is the duration of time available for responding to the request minus a predetermined assessment duration of time.

Aspect 35: The apparatus of any of Aspects 21 to 34, wherein the threshold duration of time is a predetermined percentage of the duration of time available for responding to the request.

Aspect 36: The apparatus of any of Aspects 21 to 35, wherein a plurality of responsive datasets are received from the one or more data sources in response to transmission of the plurality of requests, wherein the plurality of responsive datasets includes the first responsive dataset and the second responsive dataset, wherein the plurality of responsive datasets includes a Fair Isaac Corporation (FICO)® score, wherein the assessment is generated based on the FICO® score.

Aspect 37: The apparatus of any of Aspects 21 to 36, wherein a plurality of responsive datasets are received from the one or more data sources in response to transmission of the plurality of requests, wherein the plurality of responsive datasets includes the first responsive dataset and the second responsive dataset, wherein the plurality of responsive datasets includes information indicating a change in a property of the user, wherein generating the assessment of the user is based on the change in the property of the user, wherein the property of the user corresponds to one of a marriage status of the user, an employment status of the user, a dependent status of the user, an address of the user, and a name of the user.

Aspect 38: The apparatus of any of Aspects 21 to 37, wherein a plurality of responsive datasets are received from the one or more data sources in response to transmission of the plurality of requests, wherein the plurality of responsive datasets includes the first responsive dataset and the second responsive dataset, wherein the plurality of responsive datasets includes information indicating a plurality of changes in a parameter associated with the user over an assessed period of time, wherein the assessment is generated based on the plurality of changes in the parameter associated with the user over the assessed period of time.

Aspect 39: The apparatus of Aspect 38, wherein execution of the instructions by the processor further causes the processor to: determine a trajectory of values for the parameter over the assessed period of time based on the plurality of changes in the parameter over the assessed period of time, wherein the assessment is generated based on the trajectory of values for the parameter over the assessed period of time.

Aspect 40: The apparatus of any of Aspects 38 to 39, wherein execution of the instructions by the processor further causes the processor to: determine a sum of the plurality of changes in the parameter associated with the user over the assessed period of time, wherein the assessment is generated based on a comparison between the sum and a threshold value.

Aspect 41: A non-transitory computer readable storage medium having embodied thereon a program, wherein the program is executable by a processor to perform a method of dynamic timed decisioning, the method comprising: receiving, from a client terminal, a request for an assessment of a user; determining a duration of time available for responding to the request; starting a timer in response to receiving the request; transmitting a plurality of requests for information about the user to one or more data sources, the plurality of requests for information including at least a first request and a second request; receiving a first responsive dataset from the one or more data sources in response to transmission of the first request; determining, based on time still remaining on the timer following receipt of the first responsive dataset and on the duration of time available for responding to the request, that an optimal action for generating the assessment includes waiting for receipt of a second responsive dataset in response to transmission of the second request; receiving the second responsive dataset from the one or more data sources in response to transmission of the second request; determining, following receipt of the second responsive dataset, that the timer has counted at least a threshold duration of time, wherein the threshold duration of time is based on the time available for responding to the request; generating the assessment of the user based on the first responsive dataset and the second responsive dataset based on the timer having counted at least the threshold duration of time; and transmitting the assessment of the user to the client terminal based on timer having counted at least the threshold duration of time.

Aspect 42: The transitory computer readable storage medium of Aspect 41, the method further comprising operations according to any of Aspects 2 to 20.

Aspect 43: An apparatus for dynamic timed decisioning, the apparatus comprising means for performing operations according to any of Aspects 1 to 20.

1. A method of dynamic timed decisioning, the method comprising:
receiving, from a client terminal, a request for an assessment of a user;
determining a duration of time available for responding to the request;
starting a timer in response to receiving the request;
transmitting a plurality of requests for information about the user to one or more data sources, the plurality of requests for information including at least a first request and a second request;
receiving a first responsive dataset from the one or more data sources in response to transmission of the first request;
determining, based on time still remaining on the timer following receipt of the first responsive dataset and on the duration of time available for responding to the request, that an optimal action for generating the assessment includes waiting for receipt of a second responsive dataset in response to transmission of the second request;
receiving the second responsive dataset from the one or more data sources in response to transmission of the second request;
determining, following receipt of the second responsive dataset, that the timer has counted at least a threshold duration of time, wherein the threshold duration of time is based on the time available for responding to the request;
generating the assessment of the user based on the first responsive dataset and the second responsive dataset based on the timer having counted at least the threshold duration of time; and
transmitting the assessment of the user to the client terminal based on timer having counted at least the threshold duration of time.

2. The method of claim 1, wherein transmitting the plurality of requests includes transmitting the first request in parallel with transmitting the second request.

3. The method of claim 1, wherein transmitting the plurality of requests includes transmitting the first request before transmitting the second request.

4. The method of claim 1, wherein the optimal action includes transmitting the second request.

5. The method of claim 1, wherein transmitting the plurality of requests includes transmitting the first request after transmitting the second request.

6. The method of claim 1, wherein receipt of the first responsive dataset occurs at a first time, and wherein receipt of the second responsive dataset occurs at a second time after the first time.

7. The method of claim 1, wherein generating the assessment includes generating a grade corresponding to a level of risk associated with the user, wherein the grade is within a range of possible grades.

8. The method of claim 7, wherein the grade corresponding to the level of risk associated with the user corresponds to a creditworthiness of the user.

9. The method of claim 7, wherein the assessment includes the grade.

10. The method of claim 7, further comprising:
determining that the grade exceeds a predetermined grade threshold, wherein the assessment includes a recommendation to approve the user for at least one of a new credit account or a credit limit increase based on determining that the grade exceeds the predetermined grade threshold.

11. The method of claim 7, further comprising:
determining that the grade is less than a predetermined grade threshold, wherein the assessment includes a recommendation to decline the user for at least one of a new credit account or a credit limit increase based on determining that the grade is less than the predetermined grade threshold.

12. The method of claim 1, further comprising:
receiving a third responsive dataset from the one or more data sources in response to transmission of a third request and after the timer has counted at least the threshold duration of time, wherein the plurality of requests for information include the third request, wherein the assessment is generated without use of the third responsive dataset in response to receipt of the third responsive dataset after the timer has counted at least the threshold duration of time.

13. The method of claim 1, further comprising:
receiving a third responsive dataset from the one or more data sources in response to transmission of a third request and before the timer has counted at least the threshold duration of time, wherein the plurality of requests for information include the third request, wherein the assessment is generated based also on the third responsive dataset in response to receipt of the third responsive dataset before the timer has counted at least the threshold duration of time.

14. The method of claim 1, wherein the threshold duration of time is the duration of time available for responding to the request minus a predetermined assessment duration of time.

15. The method of claim 1, wherein the threshold duration of time is a predetermined percentage of the duration of time available for responding to the request.

16. The method of claim 1, wherein a plurality of responsive datasets are received from the one or more data sources in response to transmission of the plurality of requests, wherein the plurality of responsive datasets includes the first responsive dataset and the second responsive dataset, wherein the plurality of responsive datasets includes a Fair Isaac Corporation (FICO)® score, wherein the assessment is generated based on the FICO® score.

17. The method of claim 1, wherein a plurality of responsive datasets are received from the one or more data sources in response to transmission of the plurality of requests, wherein the plurality of responsive datasets includes the first responsive dataset and the second responsive dataset, wherein the plurality of responsive datasets includes information indicating a change in a property of the user, wherein generating the assessment of the user is based on the change in the property of the user, wherein the property of the user corresponds to one of a marriage status of the user, an employment status of the user, a dependent status of the user, an address of the user, and a name of the user.

18. The method of claim 1, wherein a plurality of responsive datasets are received from the one or more data sources in response to transmission of the plurality of requests, wherein the plurality of responsive datasets includes the first responsive dataset and the second responsive dataset, wherein the plurality of responsive datasets includes information indicating a plurality of changes in a parameter associated with the user over an assessed period of time, wherein the assessment is generated based on the plurality of changes in the parameter associated with the user over the assessed period of time.

19. The method of claim 18, further comprising:
determining a trajectory of values for the parameter over the assessed period of time based on the plurality of changes in the parameter over the assessed period of time, wherein the assessment is generated based on the trajectory of values for the parameter over the assessed period of time.

20. The method of claim 18, further comprising:
determining a sum of the plurality of changes in the parameter associated with the user over the assessed period of time, wherein the assessment is generated based on a comparison between the sum and a threshold value.

21. A system for dynamic timed decisioning, the system comprising:
a communication transceiver;
a memory storing instructions; and
a processor that executes the instructions, wherein execution of the instructions by the processor causes the processor to:
receive, from a client terminal at the communication transceiver, a request for an assessment of a user;
determine a duration of time available for responding to the request;
start a timer in response to receiving the request;
transmit a plurality of requests for information about the user to one or more data sources using the communication transceiver, the plurality of requests for information including at least a first request and a second request;
receive a first responsive dataset from the one or more data sources at the communication transceiver in response to transmission of the first request;
determine, based on time still remaining on the timer following receipt of the first responsive dataset and on the duration of time available for responding to the request, that an optimal action for generating the assessment includes waiting for receipt of a second responsive dataset in response to transmission of the second request;
receive the second responsive dataset from the one or more data sources at the communication transceiver in response to transmission of the second request;
determine, following receipt of the second responsive dataset, that the timer has counted at least a threshold duration of time, wherein the threshold duration of time is based on the time available for responding to the request;
generate the assessment of the user based on the first responsive dataset and the second responsive dataset based on the timer having counted at least the threshold duration of time; and
transmit the assessment of the user to the client terminal using the communication transceiver based on timer having counted at least the threshold duration of time.

22. A non-transitory computer readable storage medium having embodied thereon a program, wherein the program is executable by a processor to perform a method of dynamic timed decisioning, the method comprising:
receiving, from a client terminal, a request for an assessment of a user;
determining a duration of time available for responding to the request;
starting a timer in response to receiving the request;
transmitting a plurality of requests for information about the user to one or more data sources, the plurality of requests for information including at least a first request and a second request;
receiving a first responsive dataset from the one or more data sources in response to transmission of the first request;
determining, based on time still remaining on the timer following receipt of the first responsive dataset and on the duration of time available for responding to the request, that an optimal action for generating the assessment includes waiting for receipt of a second responsive dataset in response to transmission of the second request;
receiving the second responsive dataset from the one or more data sources in response to transmission of the second request;
determining, following receipt of the second responsive dataset, that the timer has counted at least a threshold duration of time, wherein the threshold duration of time is based on the time available for responding to the request;
generating the assessment of the user based on the first responsive dataset and the second responsive dataset based on the timer having counted at least the threshold duration of time; and
transmitting the assessment of the user to the client terminal based on timer having counted at least the threshold duration of time.
